(19) United States
(12) Patent Application Publication
(10) Pub. No.: US 2010/0118411 A1
(43) Pub. Date: May 13, 2010

(54) INTEGRATOR AND ILLUMINATING APPARATUS USING THE INTEGRATOR

(75) Inventor: Yasuharu Nakajima, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/689,767

(22) Filed: Jan. 19, 2010

Related U.S. Application Data
(63) Continuation of application No. PCT/JP2008/063603, filed on Jul. 29, 2008.

(30) Foreign Application Priority Data
Aug. 3, 2007 (JP) 2007-203217
Jul. 3, 2008 (JP) 2008-175027

(51) Int. Cl. G02B 27/12; G02B 27/30

(52) U.S. Cl. 359/639; 359/641

(57) ABSTRACT

Provided is a small size optical system having functions of a luminous flux splitting optical system or those of a luminous flux integrating optical system and functions of a fly's eye integrator. The integrator is provided with two surfaces. A first surface (111) is composed of a first unit surface, i.e., a positive refractive surface, and a second surface (113) is composed of a second unit surface, i.e., a positive refractive surface. Prescribed n number of second unit surfaces (113a, 113b) correspond to a prescribed first unit surface (111a). Light which entered the n number of second unit surfaces and parallel to the optical axis of the prescribed first unit surface is collected to the center of the prescribed first unit surface. The n number of second unit surfaces are arranged not to be adjacent to each other on a refractive surface having substantially the same diffractive power as that of the refractive surface of the prescribed first unit surface.

### FIELD OF THE INVENTION

The present invention relates to an integrator that splits or integrates a beam and an illuminating apparatus using the integrator.

### BACKGROUND OF THE INVENTION

In the illuminating apparatus, a fly's eye integrator is used in order to uniformize illuminance of an illuminating target region. In the illuminating apparatus, sometimes a beam splitting optical system that splits a beam emitted from a light source into plural beams or a beam integrating optical system that integrates plural beams emitted from plural light sources into a single beam is used in addition to the fly's eye integrator that uniformizes the illuminance of the illuminating target region.

For example, in a projection exposure apparatus that is used in a lithography process such as that of a semiconductor device, a quadrupole type modified illuminating apparatus in which a pupil of illumination is formed into a four-hole shape is used to improve a depth of focus or a resolution. In the quadrupole type modified illuminating apparatus, a beam splitting optical system such as a diffraction optical element and a pyramidal prism and a fly's eye integrator that uniformizes pupil illuminance are used according to the pupil having the four-hole shape (for example, Patent Document 1).

For example, a beam integrating optical system such as a dichroic prism that integrates beams from RGB three-color light sources and a fly's eye integrator that improves the illumination uniformity of the projection image are used in an image projector (for example, Patent Document 2).
Patent Document 1: Japanese Patent Application Laid-Open No. 2000-182933
Patent Document 2: Japanese Patent Application Laid-Open No. 2006-39495

However, in the optical system including the beam splitting optical system or beam integrating optical system and the fly's eye integrator, a size of the optical system is enlarged. A size of the illuminating apparatus including the optical system is also enlarged.

Accordingly, there is the need for a compact optical system having the function of the beam splitting optical system or beam integrating optical system and the function of the fly's eye integrator, and there is also the need for a compact illuminating apparatus including the optical system.

### SUMMARY OF THE INVENTION

In accordance with a first aspect of the invention, an integrator includes first and second surfaces. The first surface includes a first unit surface that is of a positive refractive surface, and the second surface includes a second unit surface that is of a positive refractive surface. Predetermined n second unit surfaces correspond to a predetermined first unit surface, and light that is parallel to the optical axis of the predetermined first unit surface and incident to each of the predetermined n second unit surfaces is collected in a center of the predetermined first unit surface. The predetermined n second unit surfaces are disposed so as not to be adjacent to one another on a refractive surface having a refractive power substantially identical to that of the refractive surface of the predetermined first unit surface.

The integrator in accordance with the first aspect of the invention acts as an integrator, and the integrator splits the light into the n beams traveling in predetermined directions after the light that is parallel to the optical axis of the predetermined first unit surface and incident to each of the predetermined n second unit surfaces is collected in the center of the predetermined first unit surface. Further, the integrator in accordance with the first aspect of the invention acts as an integrator, and the integrator integrates the n beams that travel in predetermined directions to be incident to the predetermined first unit surface into a beam parallel to the optical axis of the predetermined first unit surface.

In accordance with a second aspect of the invention, an integrator includes first and second members. The first member includes a first unit portion having a positive refractive power, and the second member includes a second unit portion having a positive refractive power. Predetermined n second unit portions correspond to a predetermined first unit portion, and light that is parallel to the optical axis of the predetermined first unit portion and incident to a surface on an incident side in each of the predetermined n second unit portions is collected in a center of a surface on an output side in the predetermined first unit portion. The predetermined n second unit portions are disposed so as not to be adjacent to one another on a member having a refractive power substantially identical to the refractive power of the predetermined first unit portion.

The integrator in accordance with the second aspect of the invention acts as an integrator, and the integrator splits the light into the n beams traveling in predetermined directions after the light that is parallel to the optical axis of the predetermined first unit portion and incident to the surface on the incident side in each of the predetermined n second unit portions is collected in the center of the surface on the output side in the predetermined first unit portion. Further, the integrator in accordance with the second aspect of the invention acts as an integrator, and the integrator integrates the n beams that travel in predetermined directions to be incident to the predetermined first unit portion into a beam parallel to the optical axis of the predetermined first unit portion.

In accordance with a third aspect of the invention, an integrator includes first and second surfaces. The first surface includes a first unit surface that is of a positive refractive surface, and the second surface includes a second unit surface that is of a positive refractive surface. Predetermined m first unit surfaces correspond to predetermined n second unit surfaces, the predetermined m first unit surfaces are disposed on a first refractive surface so as not to be adjacent to one another, the predetermined n second unit surfaces are disposed on a second refractive surface so as not to be adjacent to one another, and the first refractive surface and the second refractive surface have a substantially identical refractive power and each of the first refractive surface and the second refractive surface is disposed near the focal point on the optical axe of the other.

The integrator in accordance with the third aspect of the invention acts as an integrator, and the integrator splits the light into the m beams traveling in different directions after the n beams that travel in different directions to be incident to the predetermined m first unit surfaces at the predetermined angle are collected and integrated into the predetermined n second unit surfaces.

In accordance with a fourth aspect of the invention, an integrator includes first and second members. The first member includes a first unit portion having a positive refractive surface, and the second member includes a second unit portion having a positive refractive surface. Predetermined m first unit portions correspond to predetermined n second unit portions, the predetermined m first unit portions are disposed on the first member so as not to be adjacent to one another, and the predetermined n second unit portions are disposed on the second member so as not to be adjacent to one another. Refractive surfaces of the predetermined m first unit portions are parts of a first refractive surface, and refractive surfaces of the predetermined n second unit portions are parts of a second refractive surfaces. The first refractive surface and the second refractive surface have a substantially identical refractive power and each of the first refractive surface and the second refractive surface is disposed near the focal point on the optical axe of the other, where n and m represent positive integers.

The integrator in accordance with the fourth aspect of the invention acts as an integrator, and the integrator splits the light into the m beams traveling in different directions after the n beams that travel in different directions and are incident to the predetermined m first unit portions at the predetermined angle are collected and integrated in the predetermined n second unit portions.

Accordingly, a compact integrator having the function of the beam splitting optical system or beam integrating optical system is obtained in the invention.

### BRIEF DESCRIPTION OF THE DRAWINGS

FIG. 1 is a view illustrating a configuration of an optical system according to an embodiment of the invention.

FIG. 2 is a view illustrating configuration of an optical element that includes a first surface having plural first unit surfaces and a second surface having plural second unit surfaces.

FIG. 3 is a view illustrating an optical system in which a first unit surface is used as an incident surface, the optical system being identical to the optical system of FIG. 1.

FIG. 4 is a view illustrating a configuration of an optical element in which a first surface is used as an incident surface, the optical element being identical to the optical element of FIG. 2.

FIG. 5 is a view illustrating a configuration of an optical system according to another embodiment of the invention.

FIG. 6 is a view illustrating configurations of a first optical element that includes a first surface having plural first unit surfaces and a second optical element that includes a second surface having plural second unit surfaces.

FIG. 7 is a view illustrating an optical system in which a first unit surface is used as an incident surface, the optical system being identical to the optical system of FIG. 5.

FIG. 8 is a view illustrating a configuration of an optical element in which a first surface is used as an incident surface, the optical element being identical to the optical element of FIG. 6.

FIG. 9 is a view illustrating a configuration of an optical system according to another embodiment of the invention.

FIG. 10 is a view illustrating a configuration of a first optical element that includes a first surface having plural first unit surfaces and a second optical element that includes a second surface having plural second unit surfaces.

FIG. 11 is a view illustrating an optical system in which a first unit surface is used as an incident surface, the optical system being identical to the optical system of FIG. 9.

FIG. 12 is a view illustrating a configuration of an optical element in which a first unit surface is used as an incident surface, the optical element being identical to the optical element of FIG. 10.

FIG. 13 is a view illustrating sections including first and second surfaces when viewed from an optical axis direction and a section including an optical axis in an optical element according to a first embodiment.

FIG. 14 is a view illustrating a second surface (FIG. 14(a) and a first surface (FIG. 14(b)) of the optical element of the first embodiment.

FIG. 15 is a view illustrating a second surface (FIG. 15(a)) and a first surface (FIG. 15(b)) of an optical element according to a second embodiment.

FIG. 16 is a view illustrating a second surface (FIG. 16(a)) and a first surface (FIG. 16(b)) of an optical element according to a third embodiment.

FIG. 17 is a view illustrating a second surface (FIG. 17(a)) and a first surface (FIG. 17(b)) of an optical element according to a fourth embodiment.

FIG. 18 is a view illustrating a configuration of an illuminating apparatus according to a first embodiment in which optical element is used.

FIG. 19 is a view illustrating a configuration of an illuminating apparatus according to a second embodiment in which optical element is used.

FIG. 20 is a view illustrating a configuration of an illuminating apparatus according to a third embodiment in which optical element is used.

FIG. 21 is a view illustrating a configuration of an illuminating apparatus according to a fourth embodiment in which optical element is used.

FIG. 22 is a view illustrating a configuration of an illuminating apparatus of an image projector in which reflection type optical modulation element is used in the illuminating apparatus of FIG. 21.

FIG. 23 is a view illustrating a configuration of an optical system according to another embodiment of the invention.

FIG. 24 is a view illustrating a configuration of an optical element that includes a first surface having plural first unit surfaces and a second surface having plural second unit surfaces.

FIG. 25 is a view illustrating a configuration of an optical system according to another embodiment of the invention.

FIG. 26 is a view illustrating a configuration of a first optical element that includes a first surface having plural first unit surfaces and a second optical element that includes a second surface having plural second unit surfaces.

FIG. 27 is a view illustrating a configuration of an optical system according to another embodiment of the invention.

FIG. 28 is a view illustrating a configuration of a first optical element that includes a first surface having plural first unit surfaces and a second optical element that includes a second surface having plural second unit surfaces.

FIG. 29 is a view illustrating a section including first and second surfaces and an optical axis when viewed from an optical axis direction in an optical element according to a fifth embodiment.

FIG. 30 is a view illustrating a first surface (FIG. 30(a)) and a second surface (FIG. 30(b)) of an optical element of the fifth embodiment.

FIG. 31 is a view illustrating a first surface (FIG. 31(a)) and a second surface (FIG. 31(b)) of an optical element according to a sixth embodiment.

FIG. 32 is a view illustrating a configuration of an illuminating apparatus of a fifth embodiment in which the optical element is used.

### EXPLANATIONS OF LETTERS OR NUMERALS

110, 120, 130, and 140 optical element
111, 1111, 1113, and 1115 first surface
113, 1131, 1133, and 1135 second surface
111a, 1111a, 1113a, and 1115a first unit surface
113a, 113b, 1131a, 1131b, 1133a, 1133b, 1135a, and 1135b second unit surface

### DETAILED DESCRIPTION

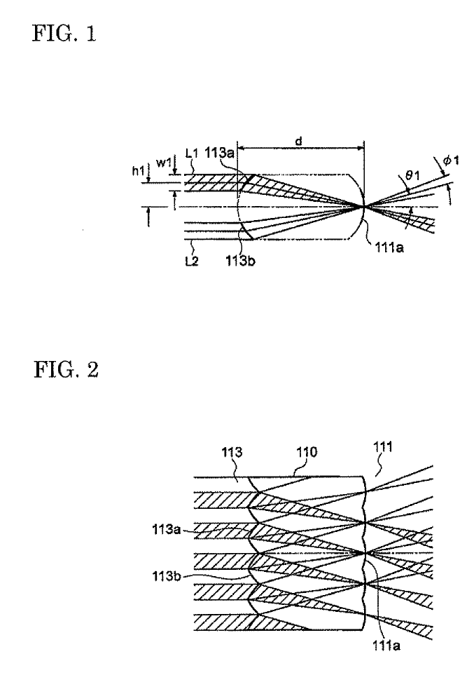

FIG. 1 is a view illustrating a configuration of an optical system according to an embodiment of the invention. The optical system includes a first unit surface 111a and second unit surfaces 113a and 113b corresponding to the first unit surface 111a. The first unit surface and the second unit surfaces are positive refractive surfaces. FIG. 1 is a sectional view including an optical axis of the first unit surface 111a. In FIG. 1 illustrating the section of the optical system, the two second unit surfaces correspond to the first unit surface 111a. However, actually there are four second unit surfaces corresponding to the first unit surface 111a.

Both the second unit surfaces 113a and 113b are partial regions on a spherical surface of a focal length f, and the second unit surfaces 113a and 113b are symmetrically disposed in relation to the optical axis of the first unit surface 111a. The first unit surface 111a is also the spherical surface of the focal length f. Gaps between the first unit surface 111a and the second unit surfaces 113a and 113b are filled with a medium having a refractive index n. An interval d between the first unit surface 111a and the second unit surfaces 113a and 113b satisfies Equation (1), and the first unit surface 111a is located on the focal point of each of the second unit surfaces 113a and 113b and each of the second unit surfaces 113a and 113b is located on the focal point of the first unit surface 111a.

f=d/n (1)

A beam L1 is parallel to the optical axis of the first unit surface 111a (hereinafter simply referred to as optical axis) and incident to the second unit surface 113a. The beam L1 is collected in the center of the first unit surface 111a by a refractive power of the second unit surface 113a, and the beam L1 exits from the first unit surface 111a at an angle θ1 formed with the optical axis diverging at a spread angle φ1. Similarly, a beam L2, which is parallel to the optical axis and incident to the second unit surface 113b and, is collected in the center of the first unit surface 111a by a refractive power of the second unit surface 113b. On the side opposite to the beam L1 in relation to the optical axis, the beam L2 exits from the first unit surface 111a at the angle θ1 formed with the optical axis as light that is divergent at the spread angle φ1.

At this point, in FIG. 1, assuming that hi is a distance between the center of the second unit surface 113a and the optical axis and w1 is a width perpendicular to the optical axis in the second unit surface 113a, the angle θ1 and the spread angle φ1 substantially satisfy Equations (2) and (3) (sine condition):

sin θ₁=h₁/f (2)

sin φ₁=w₁/2f (3)

It is not always necessary that the first unit surface 111a have the spherical surface, but the first unit surface 111a may have an aspherical surface (including a parabolic surface). It is not always necessary that the second unit surfaces 113a and 113b be the partial regions on the spherical surface, but the second unit surfaces 113a and 113b may be partial regions on an aspherical surface. It is not always necessary that a focal length (refractive power) of the first unit surface 111a be identical to focal length (refractive power) of the second unit surfaces 113a and 113b, but the first unit surface 111a and the second unit surfaces 113a and 113b may be deviated from a focal position of a paraxial to improve a function as the integrator in consideration of aberration. However, in such cases, it is assumed that the first unit surface 111a and the second unit surfaces 113a and 113b have the substantially same refractive power.

FIG. 2 is a view illustrating configuration of an optical element (integrator) 110 that includes a first surface 111 having plural first unit surfaces and a second surface 113 having plural second unit surfaces. FIG. 2 is a sectional view including the optical axis of the first unit surface.

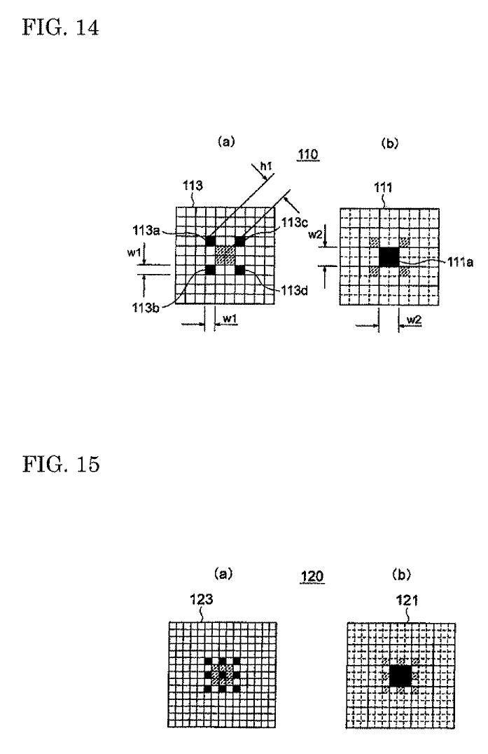

FIG. 14 is a view illustrating the first surface 111 (FIG. 14(b)) and the second surface 113 (FIG. 14(a)) when viewed from above the optical axis of the first unit surface. As described above, four second unit surfaces 113a, 113b, 113c, and 113d in the second surface 113 correspond to the first unit surface 111a in the first surface 111. The four second unit surfaces 113a, 113b, 113c, and 113d are partial regions of a sole refractive surface. The focal length of the refractive surface is equal to that of the refractive surface of the first unit surface 111a, and the optical axes of the two refractive surfaces are matched with each other. The four second unit surfaces 113a, 113b, 113c, and 113d are disposed so as not to be adjacent to one another, and the second unit surfaces 113a, 113b, 113c, and 113d are distant from the optical axis of the first unit surface 111a. As illustrated in FIG. 14, an area of the first unit surface 111a in a section perpendicular to the optical axis of the first unit surface 111a is four times an area of the second unit surfaces 113a, 113b, 113c, or 113d in a section perpendicular to the optical axis of the first unit surface 111a.

In FIG. 2, the beam, which is parallel to the optical axis of the first unit surface and incident to the second surface 113, is split into two beams. Actually the beam, which is parallel to the optical axis of the first unit surface and incident to the second surface 113, is split into four beams. As illustrated in FIG. 14, the second unit surfaces in the second surface 113 are classified into one (first group, for example, 113a) located in the upper left of the optical axis of the corresponding first unit surface, one (second group, for example, 113b) located in the lower left, one (third group, for example, 113c) located in the upper right, and one (fourth group, for example, 113d) located in the lower right. For example, the second unit surfaces of the first group are scattered on the second surface 113. The beams, which are parallel to the optical axis of the first unit surface and incident to the second unit surfaces of the first group scattered on the second surface 113, are collected in the center of the first unit surface, and then the beams exit as one beam traveling in a predetermined direction at the angle θ1 formed with the optical axis of the first unit surface from the first surface 111, diverging at the spread angle φ1. Therefore, the illuminance is uniformized in the beam. Thus, the optical element 110 uniformizes the illuminance of the beam, which is parallel to the optical axis of the first unit surface and incident to the second unit surfaces, and splits the beam into plural beams, so that the optical element 110 acts as the integrator and the beam splitting means.

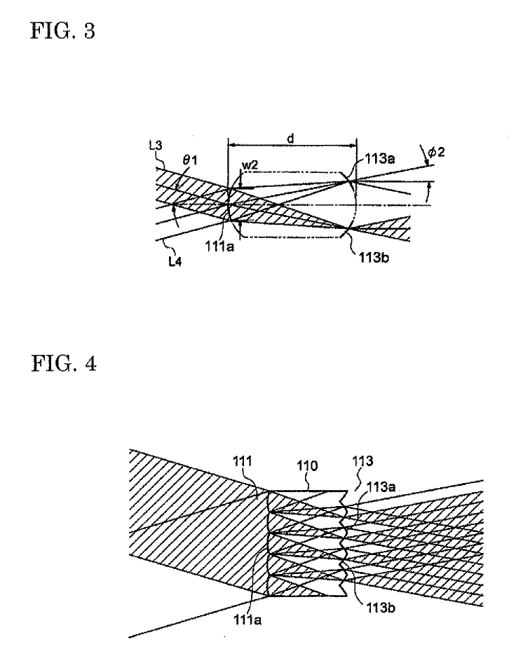

FIG. 3 is a view illustrating an optical system in which the first unit surface 111a is used as the incident surface, the optical system being identical to the optical system of FIG. 1. In FIG. 3, parallel beams L3 and L4 are incident to the first unit surface 111a that is of the incident surface from two directions that are symmetrical in relation to the optical axis of the first unit surface 111a. When the angle θ1 formed between the parallel beams L3 and L4 and the optical axis satisfies Equation (2), the parallel beams L3 and L4 are respectively collected in the centers of the second unit surfaces 113a and 113b that are of the output surface, and exit in directions parallel to the optical axe of the first unit surface 111a as lights diverging at a spread angle φ2.

At this point, assuming that w2 is a width of a refractive surface 1x, the spread angle φ2 substantially satisfies Equation (4) (sine condition):

sin φ₂=w₂/2f (4)

FIG. 4 is a view illustrating a configuration of the optical element 110 in which the first surface 111 is used as the incident surface, the optical element 110 being identical to the optical element of FIG. 2. FIG. 4 is a sectional view including the optical axis of the first unit surface.

In FIG. 4, the two parallel beams, which are incident to the first unit surface 111 that is of the incident surface at the angle θ1 formed with the optical axis of the first unit surface, are integrated into one beam that exits from the second surface 113 that is of the output surface in the direction parallel to the optical axis, diverging at the spread angle φ2. Actually the four parallel beams incident to the first surface 111 that is of the incident surface are integrated into one beam. After the light beams incident to the first unit surfaces distributed in the first surface 111 are collected on the second unit surface, the light beams are integrated into one beam that exits in the direction parallel to the optical axis of the first unit surface, diverging at the spread angle φ2, so that the illuminance of the beam is uniformized. Thus, the optical element 110 uniformizes the illuminance of plural beams incident at a predetermined angle to the first unit surface and integrates the plural beams into one beam, so that the optical element 110 acts as the integrator and the beam integrating means.

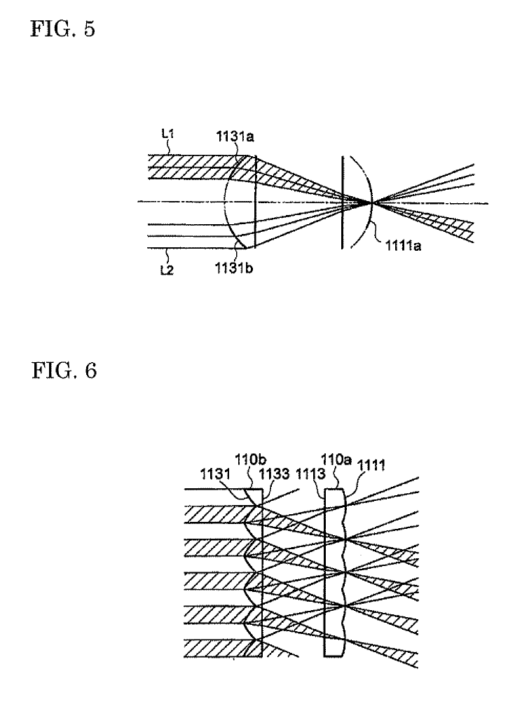

FIG. 5 is a view illustrating a configuration of an optical system according to another embodiment of the invention. The optical system of FIG. 5 includes a first unit surface 1111a and second unit surfaces 1131a and 1131b corresponding to the first unit surface 1111a. The first unit surface and the second unit surfaces are positive refractive surfaces. FIG. 5 is a sectional view including the optical axis of the first unit surface 1111a. In FIG. 5, the two second unit surfaces correspond to the first unit surface 1111a. However, actually there are four second unit surfaces corresponding to the first unit surface 1111a.

Both the second unit surfaces 1131a and 1131b are partial regions on the spherical surface, and the second unit surfaces 1131a and 1131b are symmetrically disposed in relation to the optical axis of the first unit surface 1111a. The first unit surface 1111a is a spherical surface having the same shape as the spherical surface of the second unit surfaces 1131a and 1131b.

It is not always necessary that the second unit surfaces 1131a and 1131b be partial regions on a spherical surface, but the second unit surfaces 1131a and 1131b may be partial regions on an aspherical surface (including a parabolic surface). It is not always necessary that the first unit surface 1111a have a spherical surface, but the first unit surface 111a may have an aspherical surface. It is not always necessary that the second unit surfaces 1131a and 1131b and the first unit surface 1111a have the same shape provided that the first unit surface 1111a and the second unit surfaces 1131a and 1131b have the substantially same refractive power.

The beam L1 is parallel to the optical axis of the first unit surface 1111a and incident to the second unit surface 1131a. The beam L1 is collected in the center of the first unit surface 1111a by the refractive power of the second unit surface 1131a. Similarly a beam L2, which is parallel to the optical axis of the first unit surface 1111a and incident to the second unit surface 1131b, is collected in the center of the first unit surface 1111a by the refractive power of the second unit surface 1131b.

FIG. 6 is a view illustrating configurations of a first optical element 110a including a first surface 1111 having plural first unit surfaces and a second optical element 110b including a second surface 1131 having plural second unit surfaces. FIG. 6 is a sectional view including the optical axis of the first unit surface. A surface 1113 of the first optical element 110a on the side opposite to the first surface 1111 and a surface 1133 of the second optical element 110b on the side opposite to the second surface 1131 are flat.

In FIG. 6, the beam, which is parallel to the optical axis of the first unit surface and incident to the second surface 1131, is split into two beams. Actually the beam, which is parallel to the optical axis of the first unit surface and incident to the second surface 1131, is split into four beams. Thus, the optical elements 110a and 110b act as an integrator and beam splitting means.

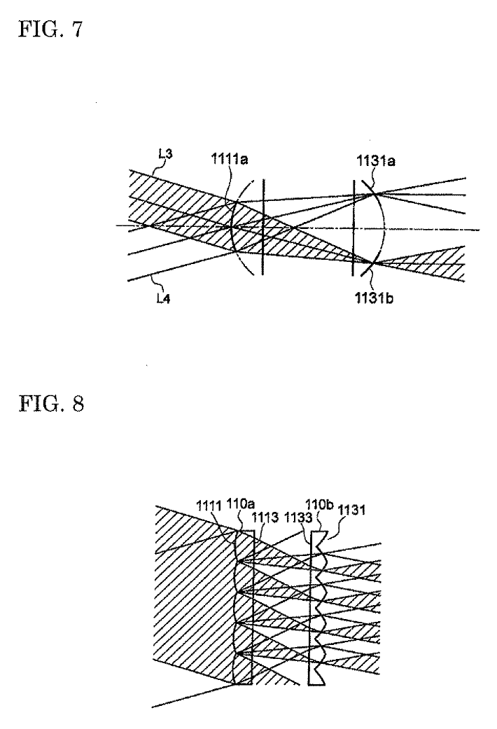

FIG. 7 is a view illustrating an optical system in which a first unit surface 1111a is used as the incident surface, the optical system being identical to the optical system of FIG. 5. In FIG. 7, the first unit surface 1111a is the incident surface. In FIG. 7, parallel beams L3 and L4, which are incident to the first unit surface 1111a that is of the incident surface from predetermined two directions that are symmetrical in relation to the optical axis of the first unit surface 1111a, are collected in the centers of the second unit surfaces 1131a and 1131b that are of the output surface, and the parallel beams L3 and L4 exit in the directions parallel to the optical axes of the first unit surface 1111a.

FIG. 8 is a view illustrating a configuration of an optical element in which a first surface 1111 is used as the incident surface, the optical element being identical to the optical element of FIG. 6. FIG. 8 is a sectional view including the optical axis of the first unit surface.

In FIG. 8, two parallel beams incident at a predetermined angle to the first surface 1111 that is of the incident surface are integrated into one beam exiting in the direction parallel to the optical axis from the second surface 1131 that is of the output surface. Actually four parallel beams incident to the first surface 1111 that is of the incident surface are integrated into one beam. Thus, the optical elements 110a and 110b act as an integrator and beam integrating means.

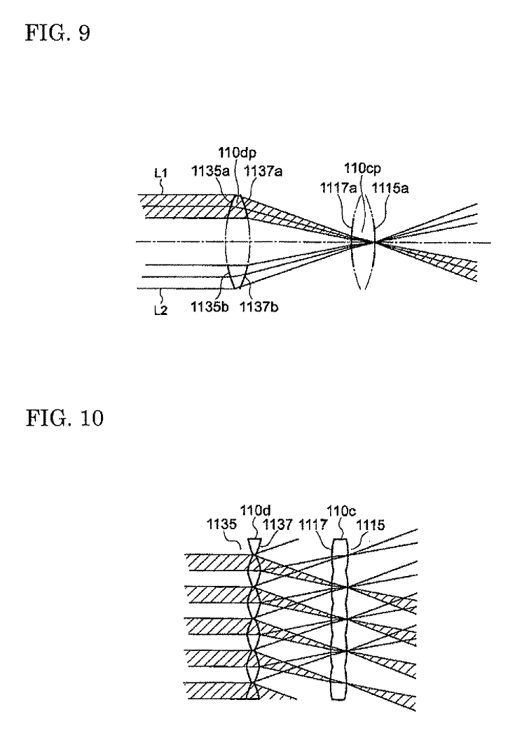

FIG. 9 is a view illustrating a configuration of an optical system according to another embodiment of the invention. The optical system includes a first unit portion 110cp and a second unit portion 110dp. The first unit portion 110cp includes a unit surface 1115a and a unit surface 1117a. The second unit portion 110dp corresponds to the first unit portion 110cp, and the second unit portion 110dp includes a unit surface 1135a and a unit surface 1137a (or second unit portion 110dp includes a unit surface 1135b and a unit surface 1137b). The first unit portion 110cp and the second unit portion 110dp have positive refractive powers. FIG. 9 is a sectional view including the optical axis of the first unit portion. In FIG. 9, the two second unit portions 110dp correspond to the first unit portion 110cp. However, actually there are four second unit portions corresponding to the first unit portion 110cp.

The unit surfaces 1135a and 1135b and the unit surfaces 1137a and 1137b are respectively partial regions of a spherical surface, and the second unit portions 110dp are symmetrically disposed in relation to the optical axis of the first unit portion 110cp. The unit surfaces 1115a and 1117a are spherical surfaces having the same shape as the spherical surfaces of the unit surfaces 1135a and 1135b and unit surfaces 1137a and 1137b.

It is not always necessary that the unit surfaces 1135a and 1135b and the unit surfaces 1137a and 1137b be partial regions on a spherical surface, but the unit surfaces 1135a and 1135b and the unit surfaces 1137a and 1137b may be partial regions on an aspherical surface (including a parabolic surface). It is not always necessary that the unit surfaces 1115a and 1117a have the spherical surfaces, but the unit surfaces 1115a and 1117a may have the aspherical surfaces. It is not always necessary that the unit surface 1135a (1135b), the unit surface 1137a (1137b), and the unit surfaces 1117a and 1115a have the same shape provided that the first unit portion 110cp and the second unit portion 110dp have the substantially same refractive power.

The beam L1, which is incident to the unit surface 1135a of the second unit portion 110dp and parallel to the optical axis of the first unit portion 110cp, is collected in the center of the unit surface 1115a by the refractive power of the second unit portion 110dp. Similarly the beam L2, which is parallel to the optical axis of the first unit portion 110cp and incident to the unit surface 1135b of the second unit portion 110dp, is collected in the center of the unit surface 1115a.

FIG. 10 is a view illustrating a configuration of an integrator that includes a first optical element 110c and a second optical element 110d. The first optical element 110c includes a surface 1115 having plural unit surfaces and a surface 1117 having plural unit surfaces. The second optical element 110d includes a surface 1135 having plural unit surfaces and a surface 1137 having plural unit surfaces. FIG. 10 is a sectional view including the optical axis of the first unit portion 110cp.

In FIG. 10, the beam, which is parallel to the optical axis of the first unit portion and incident to the surface 1135 of the second optical element 110d, is split into the two beams. Actually the beam, which is parallel to the optical axis of the first unit portion and incident to the surface 1135, is split into the four beams. Thus, the optical elements 110c and 110d act as an integrator and beam splitting means.

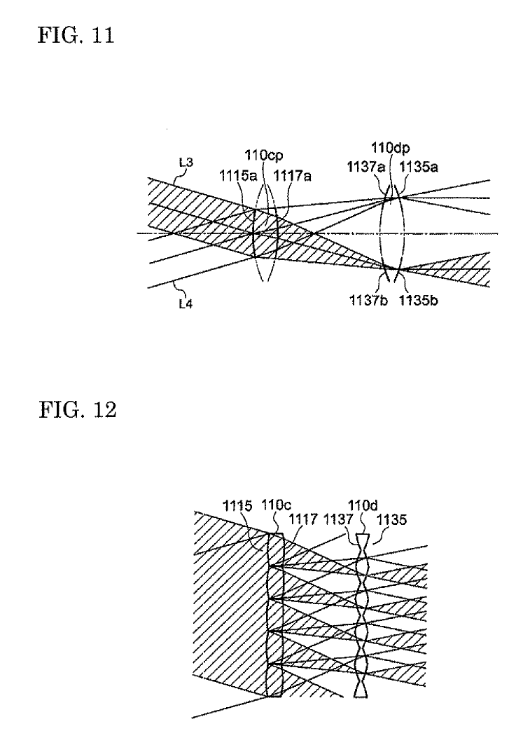

FIG. 11 is a view illustrating an optical system in which the unit surface 1115a of the first unit portion 110cp is used as the incident surface, the optical system being identical to the optical system of FIG. 9. In FIG. 11, the parallel beams L3 and L4, which are in predetermined two directions that are symmetrical in relation to the optical axis of the first unit portion 110cp and incident to the unit surface 1115a that is of the incident surface, are collected in the centers of the unit surfaces 11135a and 1135b of the second unit portions 110dp that are of the output surface, and the parallel beams L3 and L4 exit in the directions parallel to the optical axe of the first unit portion 110cp.

FIG. 12 is a view illustrating a configuration of an optical element in which the surface 1115 of the first optical element 110c is used as the incident surface, the optical element being identical to the optical element of FIG. 10. FIG. 12 is a sectional view including the optical axis of the first unit portion.

In FIG. 12, two parallel beams, which are incident at a predetermined angle to the surface 1115 that is of the incident surface, are integrated into one beam exiting in the direction parallel to the optical axis from the surface 1135 that is of the output surface. Actually four parallel beams incident to the surface 1115 that is of the incident surface are integrated into one beam. Thus, the optical elements 110c and 110d act as an integrator and beam integrating means.

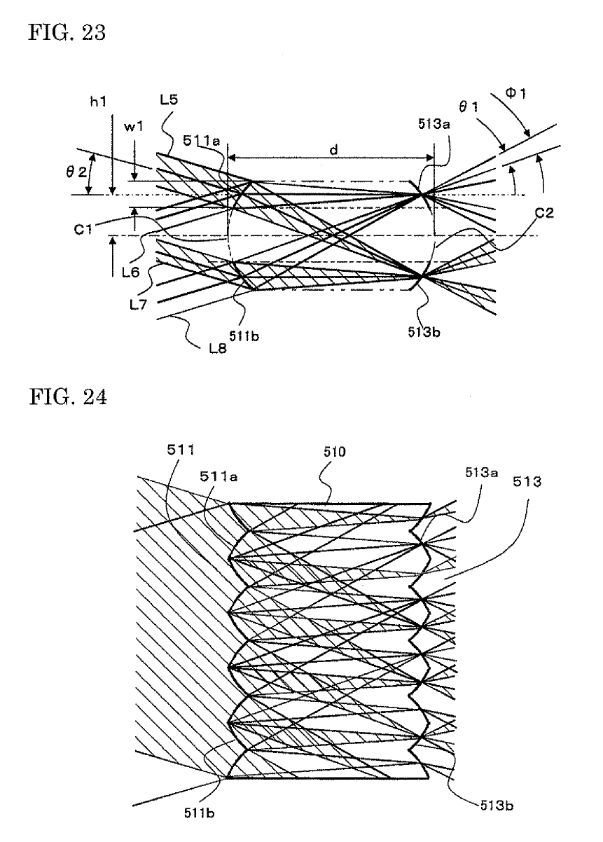

FIG. 23 is a view illustrating a configuration of an optical system according to another embodiment of the invention. The optical system includes first unit surfaces 511a and 511b and second unit surfaces 513a and 513b corresponding to the first unit surfaces 511a and 511b. The first unit surfaces and the second unit surfaces are positive refractive surfaces.

Both the first unit surfaces 511a and 511b are partial regions on a spherical surface C1 having a focal length f. Both the second unit surfaces 513a and 513b are partial regions on a spherical surface C2 having the focal length f. FIG. 23 is a sectional view including an optical axis that is defined by a straight line connecting the centers of the spherical surfaces C1 and C2 (hereinafter simply referred to as optical axis). In FIG. 23 illustrating the section of the optical system, the two first unit surfaces and the two second unit surfaces are provided. However, actually there are four first unit surfaces and four second unit surfaces.

The first unit surfaces 511a and 511b are symmetrically disposed in relation to the optical axis. Similarly the second unit surfaces 513a and 513b are symmetrically disposed in relation to the optical axis. Gaps between the first unit surfaces 511a and 511b and the second unit surfaces 513a and 513b are filled with a medium having a refractive index n. An interval d between the first unit surfaces 511a and 511b and the second unit surfaces 513a and 513b satisfies following Equation (1), and the first unit surfaces 511a and 511b are located in focal points of the second unit surfaces 513a and 513b while the second unit surfaces 513a and 513b are located in focal points of the first unit surfaces 511a and 511b.

f=d/n (1)

At this point, in FIG. 23, assuming that hi is a distance between the center of the first unit surface 511a and the optical axis and w1 is a width in a direction perpendicular to the optical axis in the first unit surface 511a, the angle θ1 and the spread angle φ1 substantially satisfy Equations (2) and (3) (sine condition), respectively.

sin θ₁32 h₁/f (2)

sin φ₁=w₁/2f (3)

Parallel beams L6 and L5 which travel in two directions that are symmetrical in relation to the optical axis and are incident to the first unit surfaces 511a, are collected in the centers of the second unit surfaces 513a and 513b that are of the output surface, respectively when the angle θ2 formed between the beams L6 and L5 and the optical axis satisfies Equation (2-1). Then the parallel beams L6 and L5 exit from the second unit surfaces 513a and 513b at the angle θ1 formed with the optical axis, diverging at the spread angle φ1, Similarly parallel beams L8 and L7 which travel in two directions that are symmetrical in relation to the optical axis and are incident to the first unit surfaces 511b, exit from the second unit surfaces 513a and 513b at the angle θ1 formed with the optical axis, diverging at the spread angle φ1, respectively.

sin θ₂=h₁/f (2-1)

It is not always necessary that the first unit surfaces 511a and 511b be a spherical surface, but the first unit surfaces 511a and 511b may be an aspherical surface (including a parabolic surface). It is not always necessary that the second unit surfaces 513a and 513b be partial regions on a spherical surface, but the second unit surfaces 513a and 513b may be partial regions on an aspherical surface. It is not always necessary that the focal length (refractive power) of the first unit surfaces 511a and 511b be identical to the focal length (refractive power) of the second unit surfaces 513a and 513b, but the first unit surfaces 511a and 511b and the second unit surfaces 513a and 513b may be deviated from a focal position of a paraxial to improve a function as the integrator (described later) in consideration of the aberration. However, in such cases, it is assumed that the first unit surfaces 511a and 511b and the second unit surfaces 513a and 513b have the substantially same refractive power.

FIGS. 30(a) and 30(b) are views illustrating the first surface 511 and the second surface 513 when viewed from above the optical axis, The first surface 511 includes four first unit surfaces 511a, 511b, 511c, and 511d, and the second surface 513 includes four second unit surfaces 513a, 513b, 513c, and 513d. The four first unit surfaces 511a, 511b, 511c, and 511d are partial regions of the same refractive surface. Similarly the four second unit surfaces 513a, 513b, 513c, and 513d are partial regions of the same refractive surface. The four first unit surfaces 511a, 511b, 511c, and 511d are disposed so as not to be adjacent to one another, and the first unit surfaces 511a, 511b, 511c, and 511d are distant from the optical axis. Similarly the four second unit surfaces 513a, 513b, 513c, and 513d are disposed so as not to be adjacent to one another, and the second unit surfaces 513a, 513b, 513c, and 513d are distant from the optical axis.

FIG. 24 is a view illustrating a configuration of an optical element (integrator) 510 that includes the first surface 511 having plural first unit surfaces and the second surface 513 having plural second unit surfaces. FIG. 24 is a sectional view including the optical axis.

In FIG. 24, two parallel beams incident to the first surface 511 at the angle θ2 formed with the optical axis are integrated in the second surface 513 that is of the output surface, and then the integrated beam is split again into the two beams exiting at the angle θ1 formed with the optical axis, diverging at the spread angle φ1 Actually, after four beams incident to the first surface 511 that is of the incident surface are integrated, the integrated beam is split into four beams again.

In FIG. 30, the first unit surfaces in the first surface 511 are classified into one (first group, for example, 511a) located in the upper left of the optical axis, one (second group, for example, 511b) located in the lower left of the optical axis, one (third group, for example, 511c) located in the upper right of the optical axis, and one (fourth group, for example, 511d) located in the lower right of the optical axis. For example, the first unit surfaces of the first group are distributed on the first surface 511. Similarly, in FIG. 30, the second unit surfaces on the second surface 513 are classified into one (fifth group, for example, 513a) located in the upper left of the optical axis, one (sixth group, for example, 513b) located in the lower left of the optical axis, one (seventh group, for example, 513c) located in the upper right of the optical axis, and one (eighth group, for example, 513d) located in the lower right of the optical axis. For example, the second unit surfaces of the fifth group are distributed on the second surface 513. After the four beams incident to the first unit surfaces of the first group at the angle θ2 formed with the optical axis are collected in the second unit surfaces of the fifth group, sixth group, seventh group, and eighth group, respectively, and the four beams exit from the second surface 513 in a predetermined direction at the angle θ1 formed with the optical axis, diverging at the spread angle φ1, so that the illuminance is uniformized in the beam. Generally, after n beams which travel in different directions and are incident to m first unit surfaces at a predetermined angle, are collected and integrated in n second unit surfaces, and the integrated beam is split into m beams traveling in different directions, where n and m represent positive integers. The optical element 510 uniformizes the illuminance of the beam incident to the first unit surface, the optical element 510 integrates plural beams, and the optical element 510 splits the integrated beam again. Therefore, the optical element 510 acts as an integrator and beam integrating and splitting means.

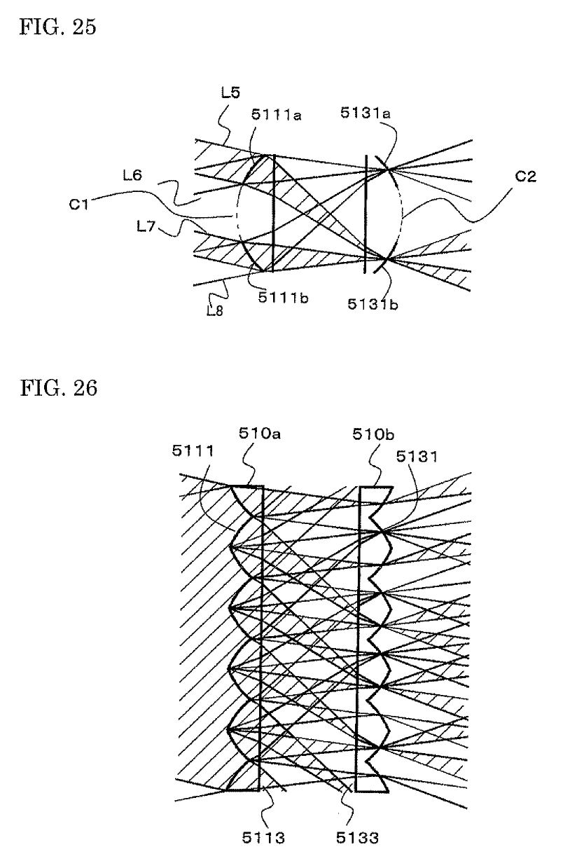

FIG. 25 is a view illustrating a configuration of an optical system according to another embodiment of the invention. The optical system includes first unit surfaces 5111a and 5111b and second unit surfaces 5131a and 5131b corresponding to the first unit surfaces 5111a and 5111b.

Both the first unit surfaces 5111a and 5111b are partial regions on the spherical surface C1 having the focal length f. Both the second unit surfaces 5131a and 5131b are partial regions on the spherical surface C2 having the focal length f. FIG. 25 is a sectional view including an optical axis that is defined by a straight line connecting the centers of the spherical surfaces C1 and C2 (hereinafter simply referred to as optical axis). In FIG. 25, the two first unit surfaces and the two second unit surfaces corresponding to the two first unit surfaces are provided. However, actually there are four first unit surfaces and four second unit surfaces.

The first unit surfaces 5111a and 5111b are symmetrically disposed in relation to the optical axis. Similarly the second unit surfaces 5131a and 5131b are symmetrically disposed in relation to the optical axis.

It is not always necessary that the first unit surfaces 5111a and 5111b be partial regions on a spherical surface, but the first unit surfaces 5111a and 5111b may be partial regions on an aspherical surface (including a parabolic surface). It is not always necessary that the second unit surfaces 5131a and 5131b be partial regions on a spherical surface, but the second unit surfaces 5131a and 5131b may be partial regions on an aspherical surface (including a parabolic surface). It is not always necessary that the first unit surfaces 5111a and 5111b and the second unit surfaces 5113a and 5113b have the same shape provided that the first unit surfaces 5111a and 5111b and the second unit surfaces 5131a and 5131b have the substantially same refractive power.

The parallel beams L6 and L5 which travel in two directions that are symmetrical in relation to the optical axis and are incident to the first unit surfaces 5111a, are collected in the centers of the second unit surfaces 5131a and 5131b, respectively by the refractive power of the first unit surface 5111a. Similarly the parallel beams L8 and L7 which travel in two directions that are symmetrical in relation to the optical axis and are incident to the first unit surfaces 5111b, are collected in the centers of the second unit surfaces 5131a and 5131b, respectively by the refractive power of the first unit surface 5111b.

FIG. 26 is a view illustrating configurations of a first optical element 510a that includes a first surface 5111 having plural first unit surfaces and a second optical element 510b that includes a second surface 5131 having plural second unit surfaces. FIG. 26 is a sectional view including the optical axis. A surface 5113 of the first optical element 510a on the side opposite to the first surface 5111 and a surface 5133 of the second optical element 510b on the side opposite to the second surface 5131 are flat.

In FIG. 26, after two parallel beams which are incident at a predetermined angle formed with the optical axis to the first surface 5111, are integrated in the second surface 5131 that is of the output surface, the integrated beam is split again into two beams exiting at a predetermined angle formed with the optical axis. Actually, after four beams incident to the first surface 5111 that is of the incident surface are integrated into one beam, the integrated beam is split again into four beams. Generally, after n beams which travel in different directions and are incident to m first unit surfaces at a predetermined angle, are collected and integrated in n second unit surfaces, the integrated beam is split into m beams traveling in different directions, where n and m represent positive integers. Thus, the optical elements 510a and 510b act as an integrator and beam integrating and splitting means.

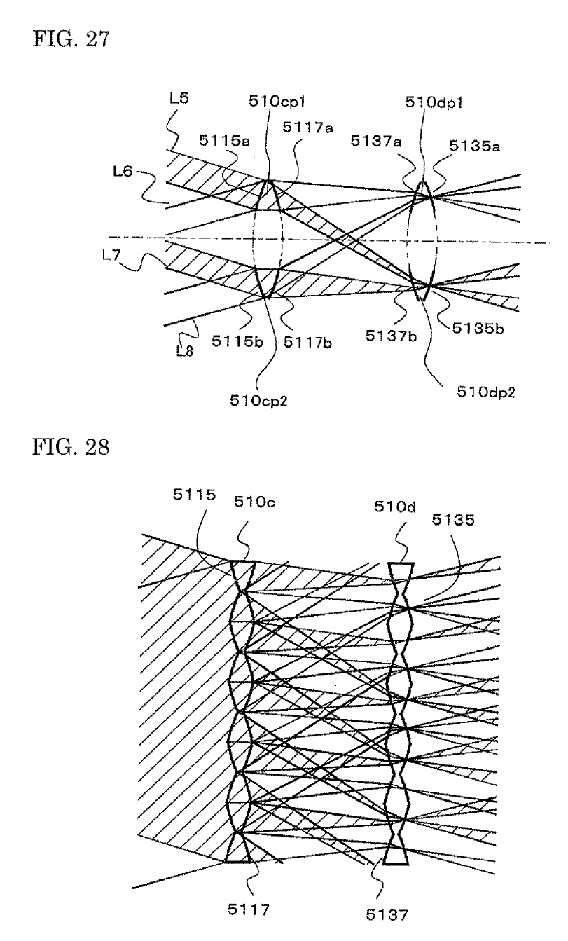

FIG. 27 is a view illustrating a configuration of an optical system according to another embodiment of the invention. The optical system includes a first unit portion 510cp1, a first unit portion 510cp2, a second unit portion 510dp1, and a second unit portion 510dp2. The first unit portion 510cp1 includes a unit surface 5115a and a unit surface 5117a. The first unit portion 510cp2 includes a unit surface 5115b and a unit surface 5117b. The second unit portion 510dp1 includes a unit surface 5135a and a unit surface 5137a. The second unit portion 510dp2 includes a unit surface 5135b and a unit surface 5137b. The second unit portions correspond to the first unit portions. The first unit portions 510cp1 and 510cp2 and the second unit portions 510dp1 and 510dp2 have positive refractive powers. FIG. 27 is a sectional view including the optical axis of the first unit portion. In FIG. 27, the two first unit portions and the two second unit portions corresponding to the first unit portions are provided. However, actually there are four first unit portions and four second unit portions.

The unit surfaces 5115a and 5115b and the unit surfaces 5117a and 5117b are partial regions on spherical surfaces, and the first unit portions 510cp1 and 510cp2 are symmetrically disposed in relation to the optical axis. The unit surfaces 5135a and 5135b and the unit surfaces 5137a and 5137b are partial regions on spherical surfaces, and the second unit portions 510dp1 and 510dp2 are symmetrically disposed in relation to the optical axis.

It is not always necessary that the unit surfaces 5115a and 5115b and the unit surfaces 5117a and 5117b be partial regions on spherical surfaces, but the unit surfaces 5115a and 5115b and the unit surfaces 5117a and 5117b may be partial regions on aspherical surfaces (including parabolic surfaces). It is not always necessary that the unit surfaces 5135a and 5135b and the unit surfaces 5137a and 5137b be partial regions on spherical surfaces, but the unit surfaces 5135a and 5135b and the unit surfaces 5137a and 5137b may be partial regions on aspherical surfaces (including parabolic surfaces). It is not always necessary that the unit surface 5115a (5115b), the unit surface 5117a (5117b), the unit surface 5135a (5135b), and the unit surface 5137a (5137b) have the same shape provided that the first unit portions 510cp1 and 510cp2 and the second unit portions 510dp1 and 510dp2 have the substantially same refractive power.

The parallel beams L6 and L5, which travel in two directions that are symmetrical in relation to the optical axis and are incident to the unit surfaces 5115a of the first unit portion 510cp1, are collected in the centers of the unit surfaces 5135a and 5135b, respectively by the refractive powers of the first unit portion 510cp1 and the second unit portions. Similarly the parallel beams L8 and L7 which travel in two directions that are symmetrical in relation to the optical axis and are incident to the unit surfaces 5115b of the first unit portion 510cp2, are collected in the centers of the unit surfaces 5135a and 5135b, respectively.

FIG. 28 is a view illustrating a configuration of an integrator that includes a first optical element 510c and a second optical element 510d. The first optical element 510c includes a surface 5115 having plural unit surfaces and a surface 5117 having plural unit surfaces. The second optical element 510d includes a surface 5135 having plural unit surfaces and a surface 5137 having plural unit surfaces. FIG. 28 is a sectional view including the optical axis.

In FIG. 28, after two parallel beams incident to the surface 5115 of the first optical element 510c at a predetermined angle formed with the optical axis of the first unit portion are integrated in the surface 5135 of the second optical element 510d, the integrated beam is split again into two beams exiting at a predetermined angle formed with the optical axis. Actually, after four beams incident to the surface 5115 at a predetermined angle formed with the optical axis of the first unit portion are integrated, the integrated beam is split again into four beams. Generally, after n beams which travel in different directions and are incident to m first unit surfaces at a predetermined angle, are collected and integrated in n second unit surfaces, the integrated beam is split into m beams traveling in different directions, where n and m represent positive integers. Thus, the optical elements 510c and 510d act as an integrator and beam integrating and splitting means.

### Optical Element (Integrator) of First Embodiment

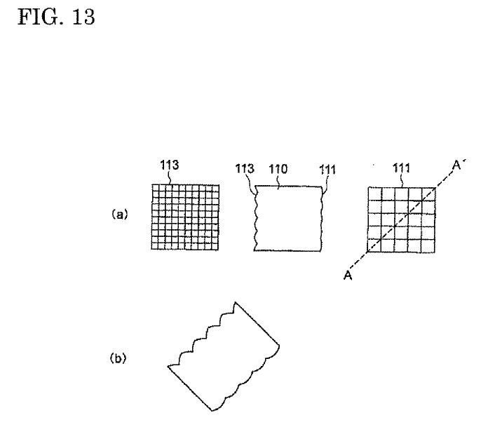

FIG. 13 is a view illustrating sections including first and second surfaces when viewed from an optical axis direction and a section including an optical axis in an optical element according to a first embodiment. As used herein the optical axis shall mean an optical axis of the first unit surface. FIG. 13(a) is a view illustrating a section including the first surface 111 when viewed from the optical axis direction, a section including the second surface 113 when viewed from the optical axis direction, and a section including the optical axis in the optical element 110. FIG. 13(b) is a view illustrating a section AA′ of the optical element 110.

The optical element 110 used in a visible ray wavelength band can be produced at low cost as an injection-molded component of thermoplastic resin. In the first embodiment, ZEONEX 480R having a refractive index n of 1.525 (product of ZEON corporation) is used as a material for the optical element 110.

The second surface 113 of the optical element 110 includes second unit surfaces. The second unit surface includes a convex spherical surface having a curvature radius r of 5.25 and a focal length f of 10. The first surface 111 of the optical element 110 includes first unit surfaces. The first unit surface also includes the convex spherical surface having the curvature radius r of 5.25 and the focal length f of 10. An interval (that is, a thickness of the optical element 110) between the first surface 111 and the second surface 113 is d of 15.25. The first surface 111 is disposed in the focal position of the second surface 113 while the second surface 113 is disposed in the focal position of the first surface 111.

FIG. 14 is a view illustrating the second surface 113 (FIG. 14(a)) and the first surface 111 (FIG. 14(b)) of the optical element 110 of the first embodiment. In the second surface 113, four second unit surfaces 113a, 113b, 113c, and 113d that are not adjacent to one another correspond to the first unit surface 111a of the first surface 111. In FIG. 14, the second unit surface is formed into a square whose one side has a length w1 of 1.5. The second unit surfaces adjacent to each other are separated by 4.5 (a size of three unit surfaces), and a distance h1 from the optical axis (center axis) of the optical element to the centers of the second unit surfaces 113a, 113b, 113c, and 113d is given by Equation (5).

h₁=1.5\sqrt{2}w₁=3.18 (5)

In FIG. 14, the first unit surface 111a of the first surface 111 is formed into a square whose one side has a length w2 of 3 (=2×w1), and the center of one of the first unit surfaces 111a (indicated in black of FIG. 14(b)) is disposed so as to be matched with the center axis of the optical element. When the first unit surfaces are arranged with no gap therebetween in the first surface 111, the second unit surfaces corresponding to the first unit surfaces can also be arranged with no gap therebetween in the second surface 113.

In the optical element 110 thus configured, when the second surface 113 is used as the incident surface, the parallel beam that is perpendicularly incident to the second surface 113 of the optical element 110 can be split into four beams, each of which travels at the angle θ1 formed with the optical axis, diverging at the spread angle φ1.

When the second surface 113 is used as the output surface, the four beams each of which is incident to the optical element 110 at the angle θ1 formed with the optical axis, can be integrated in the beam that exits in the optical axis direction, diverging at the spread angle φ2. At this point, the angle θ1 and the spread angles φ1 and φ2 are obtained as follows by Equations (1) to (3).

θ1=18.6°

φ1=4.3°

φ2=8.5°

### Optical Element (Integrator) of Second Embodiment

FIG. 15 is a view illustrating a second surface 123 (FIG. 15(a)) and a first surface 121 (FIG. 15(b)) of an optical element 120 according to a second embodiment. In the second surface 123, nine second unit surfaces (indicated in black of FIG. 15(a)) that are not adjacent to one another correspond to the first unit surface (indicated in black of FIG. 15(b)) of the first surface 121. In FIG. 15, the second unit surface is formed into a square whose one side has a length w1 of 1.0. The second unit surfaces adjacent to each other are separated by 2.0 (size of two unit surfaces).

In FIG. 15, the first unit surface of the first surface 121 is formed into a square whose one side has a length w2 of 3 (=3×w1), and the center of one of the first unit surfaces (indicated in black of FIG. 15(b)) is disposed so as to be matched with the center axis of the optical element. When the first unit surfaces are arranged with no gap therebetween in the first surface 121, the second unit surfaces corresponding to the first unit surfaces can also be arranged with no gap therebetween in the second surface 123.

In the optical element 120 thus configured, when the second surface 123 is used as the incident surface, the parallel beam that is perpendicularly incident to the second surface 123 of the optical element 120 can be split into nine beams each of which travels at a predetermined angle formed with the optical axis.

When the second surface 123 is used as the output surface, the nine beams each of which is incident to the optical element 120 at a predetermined angle formed with the optical axis can be integrated into a beam that exits in the optical axis direction.

When the optical element of the second embodiment is used as the beam splitting means, the number of second unit surfaces corresponding to one first unit surface becomes equal to the number of split beams. When the optical element of the second embodiment is used as the beam integrating means, the number of second unit surfaces corresponding to one first unit surface becomes equal to the number of integrated beams. Accordingly, the number of second unit surfaces corresponding to one first unit surface can be determined according to the number of split or integrated beams.

### Optical Element (Integrator) of Third Embodiment

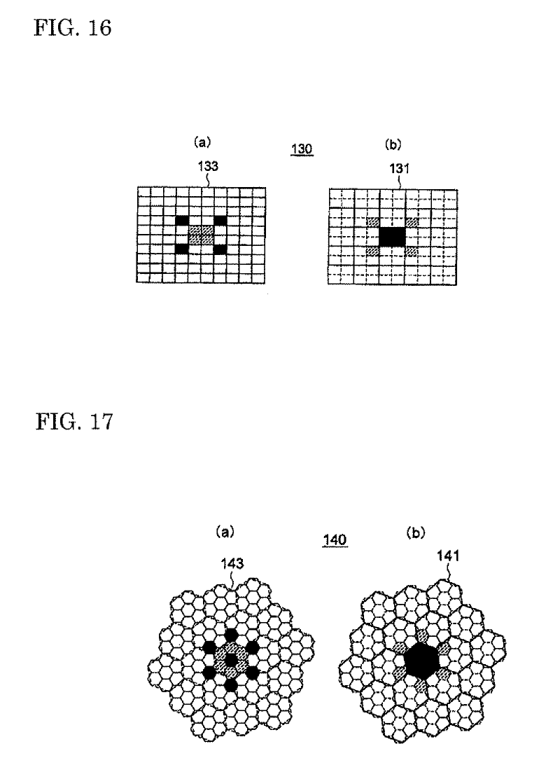

FIG. 16 is a view illustrating a second surface 133 (FIG. 16(a)) and a first surface 131 (FIG. 16(b)) of an optical element 130 according to a third embodiment. In the second surface 133, four second unit surfaces (indicated in black of FIG. 16(a)) that are not adjacent to one another correspond to the first unit surface (indicated in black of FIG. 16(b)) of the first surface 131. In FIG. 16, the first unit surface and the second unit surface are formed into rectangles.

As illustrated in FIG. 16, when the first unit surfaces are arranged with no gap therebetween in the first surface 131, the second unit surfaces corresponding to the first unit surfaces can also be arranged with no gap therebetween in the second surface 133.

In the optical element 130 thus configured, when the second surface 133 is used as the incident surface, the parallel beam that is perpendicularly incident to the second surface 133 of the optical element 130 can be split into four beams each of which travels at a predetermined angle formed with the optical axis.

When the second surface 133 is used as the output surface, four beams each of which is incident to the optical element 130 at a predetermined angle formed with the optical axis can be integrated into a beam that exits in the optical axis direction.

Because the incident surface of the optical element is disposed in a position conjugate with the illuminated region, desirably an end face of the incident surface has a shape close to the shape of an actually required illuminated region. For example, in cases where the optical element is used in an apparatus in which an image of the illuminated region is taken with a CCD camera or in a liquid crystal projector, the end face of the incident surface is formed into a rectangle having an aspect ratio close to that of an image pickup device or an image modulation device as illustrated in FIG. 16, which allows efficient illumination.

### Optical Element (Integrator) of Fourth Embodiment

FIG. 17 is a view illustrating a second surface 143 (FIG. 17(a)) and a first surface 141 (FIG. 17(b)) of an optical element 140 according to a fourth embodiment. In the second surface 143, seven second unit surfaces (indicated in black of FIG. 17(a)) that are not adjacent to one another correspond to the first unit surface (indicated in black of FIG. 17(b)) of the first surface 141. In FIG. 17, the first unit surface and the second unit surface are formed into regular hexagons.

As illustrated in FIG. 17, when the first unit surfaces are arranged with no gap therebetween in the first surface 141, the second unit surfaces corresponding to the first unit surfaces can also be arranged with no gap therebetween in the second surface 143.

In the optical element 140 thus configured, when the second surface 143 is used as the incident surface, the parallel beam that is perpendicularly incident to the second surface 143 of the optical element 140 can be split into the seven beams each of which travels at a predetermined angle formed with the optical axis.

When the second surface 143 is used as the output surface, the seven beams each of which is incident to the optical element 140 at a predetermined angle formed with the optical axis can be integrated into a beam that exits in the optical axis direction.

Because the incident surface of the optical element is disposed in a position conjugate with an illuminated region, desirably an end face of the incident surface has a shape close to the shape of an actually required illuminated region. For example, in cases where the optical element is required to illuminate a circular region such as in a microscope, the end face of the incident surface is formed into a regular hexagon as illustrated in FIG. 17, which allows efficient illumination.

### Optical Element (Integrator) of Fifth Embodiment

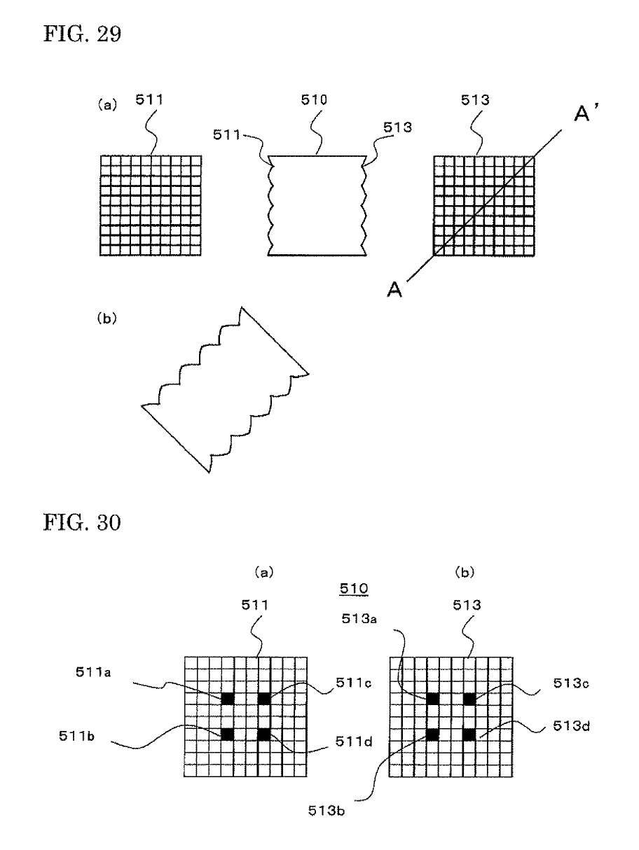

FIG. 29 is a view illustrating sections including first and second surfaces respectively when viewed from an optical axis direction and a section including an optical axis in an optical element according to a fifth embodiment. As used herein, the optical axis shall mean an optical axis of the first unit surface. FIG. 29(a) is a view illustrating a section including a first surface 511 when viewed from the optical axis direction, a section including a second surface 513 when viewed from the optical axis direction, and a section including the optical axis in an optical element 510. FIG. 29(b) is a view illustrating a section AA′ of the optical element 510. In FIG. 29, the second unit surface is formed into a square whose one side has a length w1 of 1.5.

FIG. 30 is a view illustrating the first surface 511 (FIG. 30(a)) and the second surface 511 (FIG. 30(b)) of the optical element 510 of the fifth embodiment. In the second surface 513, four second unit surfaces 513a, 513b, 513c, and 513d that are not adjacent to one another correspond to four first unit surfaces 511a, 511b, 511c, and 511d that are not adjacent to one another in the first surface 511. In FIG. 30, the first unit surface and the second unit surface are formed into a square whose one side has a length w1 of 1.5. Adjacent first unit surfaces are separated from each other by 3 (size of two unit surfaces), and adjacent second unit surface are separated from each other by 3 (size of two unit surfaces).

In the fifth embodiment, the number of first unit surfaces becomes equal to the number of split beams. The number of second unit surfaces becomes equal to the number of integrated beams. In the optical element 510 thus configured, when the first surface 511 is used as the incident surface, after four parallel beams each of which is incident to the first surface 511 of the optical element 510 at a predetermined angle formed with the optical axis are integrated, the integrated beam can be split into four beams each of which travels at a predetermined angle formed with the optical axis.

### Optical Element (Integrator) of Sixth Embodiment

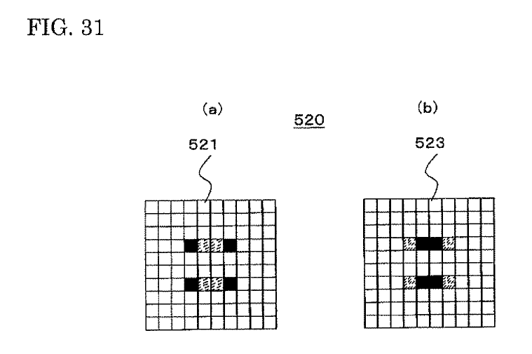

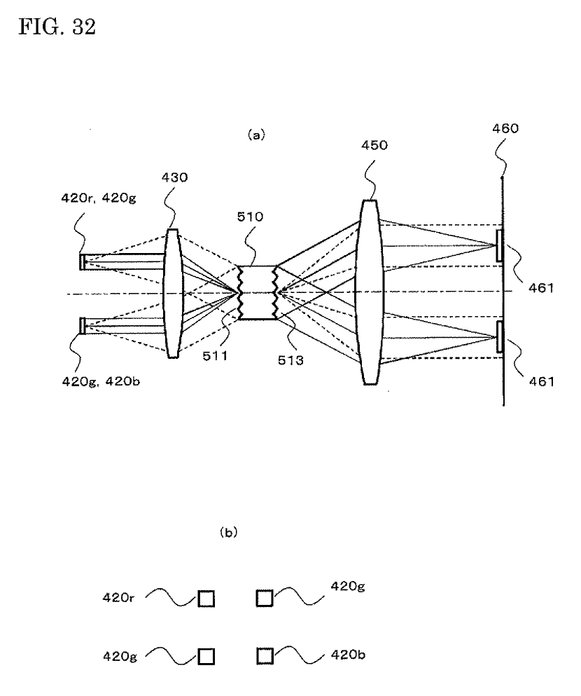

FIG. 31 is a view illustrating a first surface 521 (FIG. 32(a)) and a second surface 523 (FIG. 31(b)) of an optical element 520 according to a sixth embodiment. In the second surface 523, two second unit surfaces (indicated in black of FIG. 31(b)) that are not adjacent to each other correspond to the four first unit surfaces (indicated in black of FIG. 31(a)) of the first surface 521 which are not adjacent to one another. In FIG. 31, the first unit surface is formed into a square whose one side has a length of 1, and the second unit surface is formed into a rectangular in which a short side has a length of 1 and a long side has a length of 2.

As illustrated in FIG. 31, when the first unit surfaces are arranged with no gap therebetween in the first surface 521, the second unit surfaces corresponding to the first unit surfaces can also be arranged with no gap therebetween in the second surface 523.

In the sixth embodiment, the number of first unit surfaces becomes equal to the number of split beams. The number of second unit surfaces becomes equal to the number of integrated beams. In the optical element 520 thus configured, when the first surface 521 is used as the incident surface, two parallel beams each of which is incident to the optical element 520 at a predetermined angle formed with the optical axis are integrated, and then the integrated beam can be split into four beams each of which travels at a predetermined angle formed with the optical axis.

When the first surface 521 is used as the output surface, four beams each of which is incident to the optical element 520 at a predetermined angle formed with the optical axis are integrated, and then the integrated beam can be split into two beams each of which travels at a predetermined angle formed with the optical axis.

### Illuminating Apparatus of First Embodiment

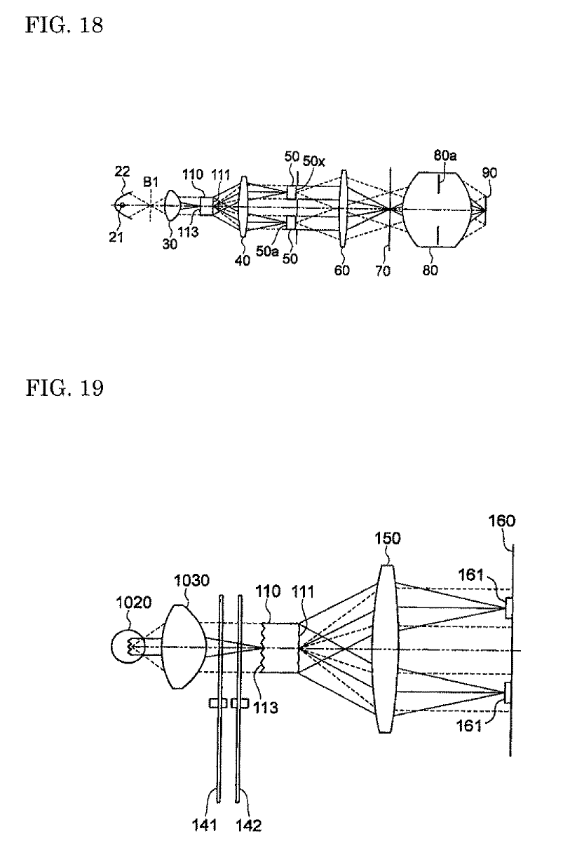

FIG. 18 is a view illustrating a configuration of an illuminating apparatus according to a first embodiment in which optical element is used. The illuminating apparatus of the first embodiment is a quadrupole type modified illuminating apparatus that is used to improve a depth of focus or a resolution in a projection exposure apparatus used to produce a semiconductor device or the like.

An illuminating beam emitted from a light source 21 such as a mercury vapor lamp is collected by an ellipsoidal mirror 22, and the illuminating beam is formed into a substantially parallel beam by an input lens (collimator lens) 30, and the parallel beam is incident to the optical element 110. Four second unit surfaces correspond to the first unit surface of the optical element 110. When the second surface 113 of the optical element 110 is disposed as the incident surface, the optical element 110 is used as beam splitting means and light uniformizing means.

The illuminating beam is split into four beams by the optical element 110, and the four beams are collected by a first collective lens 40. Four secondary light sources are formed with uniform illuminance in a focal position on an exit side (back side) of the first collective lens 40.

Four fly's eye integrators 50 are provided in positions at which the secondary light sources are formed. The four fly's eye integrators 50 are a fly's eye integrator having a conventional shape. The beams emitted from the four fly's eye integrators 50 are collected by a second collective lens 60, and a reticle 70 is uniformly illuminated at a predetermined inclination.

A predetermined circuit pattern is formed in a surface of the reticle 70 opposite to the illuminated surface. Light of the inclined illumination that is transmitted and diffracted by the reticle pattern is collected to form a pattern image of the reticle 70 on a wafer 90 by a projection optical system 80.

As illustrated by dotted lines of FIG. 18, a light source image B1 by the ellipsoidal mirror 22, the first surface 111 of the optical element 110, and an output side surface 50x of the fly's eye integrator 50 are provided in positions conjugate with an entrance pupil plane (aperture stop 80a) of the projection optical system. In other words, the light source image B1, the first surface 111 of the optical element 110, and the output side surface 50x of the fly's eye integrator 50 become Fourier transform surface of object surfaces (reticle 70 and wafer 90). As illustrated by a solid line of FIG. 18, the second surface 113 of the optical element 110 and an incident-side side surface 50a of the fly's eye integrator 50 are provided in positions conjugate with the object surfaces (reticle 70 and wafer 90).

As described above, the use of the optical element 110 that acts as a fly's eye integrator and beam splitting means eliminates the need for using independent beam splitting means, so that a compact optical system can be formed.

### Illuminating Apparatus of Second Embodiment

FIG. 19 is a view illustrating a configuration of an illuminating apparatus according to a second embodiment in which optical element is used. The illuminating apparatus of the second embodiment is an illuminating apparatus that is used to illuminate light receiving surfaces of plural solid-state image pickup devices with light in inspecting electric characteristics of the solid-state image pickup devices such as CCD (Charge-Coupled Device) and CMOS.

The illuminating beam emitted from a light source 1020 such as a halogen lamp, a xenon lamp, and a metal halide lamp is formed into a substantially parallel beam by an input lens (collimator lens) 1030, and the parallel beam passes through an ND filter turret 141 and a color filter turret 142.

The ND filter turret 141 having a circular shape is supported while being rotatable about a support shaft. The ND filter turret 141 retains plural kinds of ND (Neutral Density) filters along a circumferential direction. A ND filter attenuates the light emitted from the light source 1020 at a predetermined ratio without changing a spectral composition. The ND filter turret 141 is rotated to select a ND filter having a desired light attenuation amount, thereby performing adjustment to a light quantity suitable to the inspection.

The color filter turret 142 having a circular shape is supported while being rotatable about a support shaft. The color filter turret 142 retains plural kinds of color filters along a circumferential direction. A color filter transmits only light having a predetermined wavelength in the light emitted from the light source 1020. A wavelength of the transmitted light is selected by rotating the color filter turret 142.

The beam transmitted through the ND filter turret 141 and color filter turret 142 is incident to the optical element 110. At this point, four second unit surfaces correspond to the first unit surface of the optical element 110. The optical element 110 is used as a beam splitting means and light uniformizing means by disposing the second surface 113 of the optical element 110 as the incident surface.

The illuminating beam is split into four beams by the optical element 110, and the split beams are collected by a condenser lens 150. Four solid-state image pickup devices 161 that are of inspection targets are disposed in a focal position on the exit side (back side) of the condenser lens 150, and the solid-state image pickup devices 161 are illuminated with uniform illuminance by the split beams, respectively.

In the second embodiment, four second unit surfaces correspond to one first unit surface of the optical element. However, the invention is not limited to four second unit surfaces. As described above, because the number of second unit surfaces corresponding to one first unit surface of the optical element becomes equal to the number of split beams, the number of second unit surfaces may appropriately be selected according to the number of simultaneously-inspected solid-state image pickup devices that are of the inspection targets. For example, the second optical element of FIG. 15 (the number of splits is nine) may be used.

Thus, the use of the optical element 110 that acts as a fly's eye integrator and beam splitting means eliminates the need for using independent beam splitting means, so that a compact optical system can be formed.

### Illuminating Apparatus of Third Embodiment

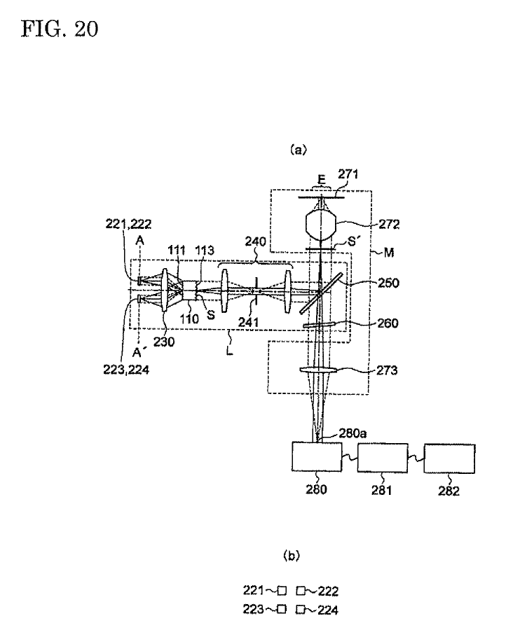

FIG. 20 is a view illustrating a configuration of an illuminating apparatus according to a third embodiment in which optical element is used. The illuminating apparatus of the third embodiment is an epi-fluorescent optical system of a microscope apparatus.

As illustrated in FIG. 20(a), the microscope apparatus includes a microscope main body M, an epi-fluorescent optical system L, an image pickup apparatus 280, an image processing device 281, and a display device 282. A biological sample 271 previously labeled with a fluorescent material is set in the microscope apparatus.

The microscope main body M includes an infinity objective lens 272 and an imaging lens 273.

The epi-fluorescent optical system L includes four kinds of light sources 221 to 224 having different illuminating light wavelengths, a collimator lens 230, an optical element 110, a relay lens 240, a field stop 241, and a dichroic mirror 250. The dichroic mirror 250 is disposed between the objective lens 272 and the imaging lens 273 in the microscope main body M. A bandpass filter 260 is disposed between the dichroic mirror 250 and the imaging lens 273.

FIG. 20(b) is a view illustrating an arrangement of the light sources 221 to 223. The light sources 221 to 224 are a solid-state light source that emits light having a center wavelength in waveband of an ultraviolet ray (wavelength of 340 nm to 400 nm) or a visible ray (wavelength of about 400 nm to about 700 nm).

Desirably the light source is selected such that an exciting wavelength of the fluorescent material is matched with the center wavelength of the light source. For example, desirably a light source such as GaN LED is used when the fluorescent material has an exciting wavelength of an ultraviolet ray to a blue ray (300 nm to 500 nm). Because desirably a broadband white light source is used to observe a bright-field color image, a light source such as a white LED is desirably used. In the white LED, a GaN blue LED emitting the light having the exciting wavelength and YAG (Yttrium Aluminum Garnet) fluorescent emission are combined.

In the collimator lens 230, a front focus is disposed in the positions of the light sources 221 to 224 to collimate the beams exiting from the light sources 221 to 224.

The collimated beams are incident to the optical element 110 that is disposed in a back focus of the collimator lens 230 at an angle θ formed with the optical axis. At this point, assuming that h is an offset amount from the optical axis of the collimator lens 230 of the light sources 221 to 224 and f is a focal length of the collimator lens, the angle θ, the offset amount h, and the focal length f satisfy the following Equation (6).

h=f sin θ (6)

As illustrated in FIG. 14, four second unit surfaces correspond to one first unit surface of the optical element 110. When the second surface 113 of the optical element 110 is used as the output surface, the optical element 110 acts as light source switching means and light uniformizing means. One of the light sources 221 to 224 is lit on as one of plural exciting light sources or a color observation white light source, which allows switching of the beams.

A secondary light source images S are formed in the second surface 113 of the optical element 110.

The relay lens 240 relays the secondary light source image S to a back focal surface (pupil plane) of the objective lens 272. The dichroic mirror 250 reflects the excitation beam to guide the excitation beam toward the objective lens 272.

The beam (excitation beam) exiting from a light source image S′ formed in the pupil plane of the objective lens 272 is collimated by the objective lens 272, and the beam is incident to an illuminated region E of the sample 271.

The field stop 241 is disposed in a position conjugate with the sample 271, and the field stop 241 has a function of restricting the illuminated region E on the sample 271.

In the illuminated region E on the sample 271, the fluorescent material is excited to generate fluorescence. The fluorescent wavelength is longer than the wavelength (500 nm or less) of the excitation beam and, for example, the fluorescent wavelength ranges from about 520 nm to about 590 nm.

The beam including the fluorescence is converted by the objective lens 272 into such a beam as forms a fluorescent image of the sample 271 in the infinite distance. The fluorescent beam is transmitted through the dichroic mirror 250 and incident to the bandpass filter 260 and the imaging lens 273. The bandpass filter 260 cuts excessive light having a wavelength different from that of the fluorescent beam (in this case, wavelength of 520 nm to 590 nm).

An image pickup surface 280a of the image pickup apparatus 280 is disposed in a back focal surface of the imaging lens 273, and the image (fluorescent image) of the sample 271 is formed on the image pickup surface 280a by the fluorescent beam.

Dotted lines in FIG. 20 indicate a conjugate relationship among the sample 271, the image pickup surface 280a, and the field stop 241.

In the image pickup apparatus 280, the fluorescent image formed on the image pickup surface 280a is taken, and the obtained image data is transmitted to the image display device 282 through the image processing device 281. The image display device 282 displays the fluorescent image.

In the third embodiment, four second unit surfaces correspond to one first unit surface of the optical element 110. However, the invention is not limited to four second unit surfaces. As described above, because the number of second unit surfaces corresponding to one first unit surface of the optical element 110 becomes equal to the number of split beams, the number of second unit surfaces may appropriately be selected according to the number of light sources. For example, the second optical element of FIG. 15 (the number of splits is nine) may be used.

Thus, the use of the optical element 110 that acts as a fly's eye integrator and beam integrating means eliminates the need for using independent beam integrating means, so that a compact optical system can be formed.

### Illuminating Apparatus of Fourth Embodiment

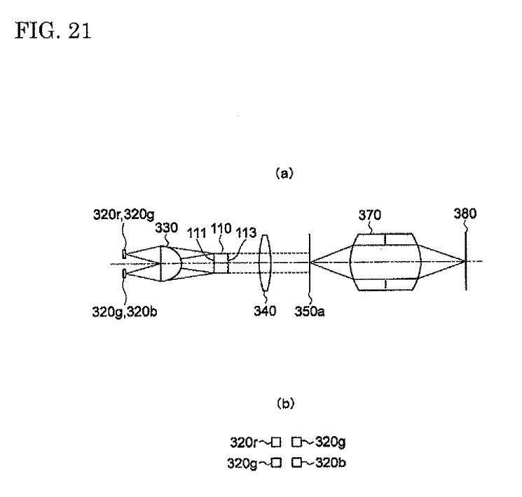

FIG. 21 is a view illustrating a configuration of an illuminating apparatus according to a fourth embodiment in which optical element is used. The illuminating apparatus of the fourth embodiment is an illuminating apparatus of an image projector.

FIG. 21(b) is a view illustrating an arrangement of light sources 320r, 320g, and 320b. In FIGS. 21(a) and 21(b), the light sources 320r, 320g, and 320b are red, green, and blue Light Emitting Diodes (LEDs), respectively. One red LED 320r, two green LEDs 320g, and one blue LED 320b are disposed in the fourth embodiment. Because the green LED has lower light emission efficiency than those of the other color LEDs, the two green LEDs are disposed such that a color balance is maintained.

In a collimator lens 330, a front focus is disposed in the positions of the light sources 320r, 320g, and 320b to collimate the beams exiting from the light sources 320r, 320g, and 320b.

The collimated beams are incident to the optical element 110 disposed in the back focus of the collimator lens 330 at the angle θ formed with the optical axis. At this point, assuming that h is an offset amount from the optical axis of the collimator lens 330 of in the light sources 320r, 320g, and 320b and f is a focal length of the collimator lens, the angle θ, the offset amount h, and the focal length f satisfy Equation (6).

As illustrated in FIG. 14, four second unit surfaces correspond to one first unit surface of the optical element 110. When the second surface 113 of the optical element 110 is used as the output surface, the optical element 110 acts as light source switching means and light uniformizing means.

RGB can be mixed by the configuration of FIG. 21. Particularly the illuminating apparatus of the fourth embodiment is suitable to an image projector apparatus in which color images are projected in time-shared manner by alternately lighting on the RGB light sources.

An optical modulation element 350a is uniformly illuminated with the beams that are mixed by the optical element 110 and pass through a condenser lens 340.

An enlarged image of beam modulated by the optical modulation element 350a is formed on a screen 380 by a projection optical system 370.

In the fourth embodiment, the optical modulation element 350a is formed in a transmission type optical modulation element.

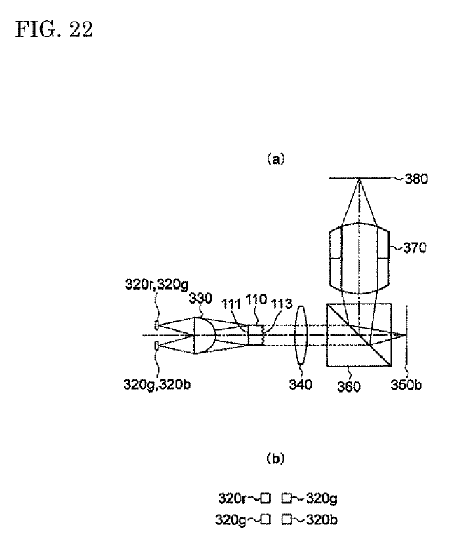

FIG. 22 is a view illustrating a configuration of an illuminating apparatus of an image projector in which a reflection type optical modulation element 350b is used in the illuminating apparatus of FIG. 21. In the illuminating apparatus of FIG. 22, the optical element 110 is used in a manner similar to that of the illuminating apparatus of FIG. 21.

### Illuminating Apparatus of Fifth Embodiment

FIG. 32 is a view illustrating a configuration of an illuminating apparatus of a fifth embodiment in which the optical element is used. The illuminating apparatus of the fifth embodiment is an illuminating apparatus that is used to irradiate light receiving surfaces of plural solid-state image pickup devices with light in inspecting electric characteristics of the solid-state image pickup devices such as CCD (Charge-Coupled Device) and CMOS (Complementary Metal-Oxide Semiconductor).

FIG. 32(b) is a view illustrating an arrangement of light sources 420r, 420g, and 420b. In FIGS. 32(a) and 32(b), the light sources 420r, 420g, and 420b are red, green, and blue Light Emitting Diodes (LEDs), respectively. One red LED 420r, two green LEDs 420g, and one blue LED 420b are disposed in the fifth embodiment. Because the green LED has a lower light emission efficiency than those of the other color LEDs, the two green LEDs are disposed such that a color balance is maintained.

In a collimator lens 430, a front focus is disposed in the positions of the light sources 420r, 420g, and 420b to collimate the beams exiting from the light sources 420r, 420g, and 420b.

The collimated beams are incident to the optical element 510 disposed in the back focus of the collimator lens 430 at the angle θ formed with the optical axis. At this point, assuming that h is an offset amount from the optical axis of the collimator lens 430 of the light sources 420r, 420g, and 420b, and f is a focal length of the collimator lens, the angle θ, the offset amount h, and the focal length f satisfy the Equation (6).

h=f sin θ (6)

The collimated beam is incident to the optical element 510. At this point, in the optical element 510, there are four first unit surfaces, and there are four second unit surfaces. Therefore, the optical element 510 is used as beam integrating means, beam splitting means, and light uniformizing means.

The illuminating beam is split into the four beams by the optical element 510, and each of the split beams is collected by the condenser lens 450. Four solid-state image pickup devices 461 that are of the inspection targets are disposed in a focal position on the exit side (back side) of the condenser lens 450, and the solid-state image pickup devices 461 are illuminated with uniform illuminance by the split beams, respectively.

In the fifth embodiment, four unit surfaces are included in the set of first unit surface. However, the invention is not limited to four unit surfaces. As described above, because the number of unit surfaces included in the set of first unit surfaces becomes equal to the number of split beams, the number of unit surfaces may appropriately be selected according to the number of simultaneously-inspected solid-state image pickup devices that are of the inspection targets.

In the fifth embodiment, four unit surfaces are included in the set of second unit surface. However, the invention is not limited to four unit surfaces. As described above, because the number of unit surfaces included in the set of second unit surfaces becomes equal to the number of integrated beams, the number of unit surfaces may appropriately be selected according to the number of light sources.

Thus, the use of the optical element 510 that acts as a fly's eye integrator, beam splitting means, and beam integrating means eliminates the need for using independent beam splitting means and beam integrating means, so that a compact optical system can be formed.

The features of embodiments of the invention will be described below.

In an integrator according to one embodiment, a size of a section of the predetermined first unit surface is n times a size of a section of each of the predetermined n second unit surfaces. The section of the predetermined first unit surface is perpendicular to the optical axis of the predetermined first unit surface, and the section of each of the predetermined n second unit surfaces is perpendicular to the optical axis of the predetermined first unit surface.

Accordingly, the size of the first surface is conveniently equalized to the size of the second surface.

In an integrator according to another embodiment, the predetermined first unit surfaces are disposed in the first surface with no gap therebetween.

The integrator of the embodiment is efficient because of no loss of the light incident to the first surface.

In an integrator according to another embodiment, the predetermined second unit surfaces are disposed in the second surface with no gap therebetween.

The integrator of the embodiment is efficient because of no loss of the light incident to the second surface.

In an integrator according to another embodiment, a shape of a section of the predetermined first unit surface and a section of each of the predetermined n second unit surfaces have square shapes. The section of the predetermined first unit surface is perpendicular to the optical axis of the predetermined first unit surface, and the section of each of the predetermined n second unit surfaces is perpendicular to the optical axis of the predetermined first unit surface.

Accordingly, the square illuminated region is conveniently irradiated.

In an integrator according to another embodiment, a section of the predetermined first unit surface and a section of each of the predetermined n second unit surfaces have rectangular shapes. The section of the predetermined first unit surface is perpendicular to the optical axis of the predetermined first unit surface, and the section of each of the predetermined n second unit surfaces is perpendicular to the optical axis of the predetermined first unit surface.

Accordingly, the rectangular illuminated region is conveniently irradiated. The rectangle is formed into a rectangle having an aspect ratio close to that of the image pickup device or image modulation element, which allows the illuminated region to be efficiently irradiated.

In an integrator according to another embodiment, a section of the predetermined first unit surface and a section of each of the predetermined n second unit surfaces have regular hexagonal shapes. The section of the predetermined first unit surface is perpendicular to the optical axis of the predetermined first unit surface, and the section of each of the predetermined n second unit surfaces is perpendicular to the optical axis of the predetermined first unit surface.

Accordingly, the circular illuminated region is conveniently irradiated. In the microscope and the like, the circular illuminated region can conveniently be irradiated.

An integrator according to another embodiment includes one optical element.

Accordingly, the compact integrator in which the beam is split or integrated by one optical element is implemented in the integrator of the embodiment.

An integrator according to another embodiment includes a first optical element including a surface in which the first unit surface is formed; and a second optical element including a surface in which the second unit surface is formed.

Accordingly, the compact integrator in which the beam is split or integrated by two optical elements is implemented in the integrator of the embodiment.

In an integrator according to another embodiment, after light that is incident to each of the predetermined n second unit surfaces and parallel to the optical axis of the predetermined first unit surface is collected on the predetermined first unit surface, the light is split into n beams traveling in different directions.

Accordingly, the compact integrator having the beam splitting function is obtained.

An illuminating apparatus according to one embodiment of the invention includes a light source; collimating means; and the integrator according to one embodiment. In the illuminating apparatus, after light emitted from the light source is formed into light parallel to the optical axis of the predetermined first unit surface by the collimating means, the light is incident to the predetermined n second unit surfaces, and the light is split into n beams traveling in different directions by the integrator.

Accordingly, the compact illuminating apparatus having the illuminance uniformizing function and the beam splitting function is obtained.

In an integrator according to another embodiment, after n beams that travel in different directions to be incident to the predetermined first unit surface at a predetermined angle are collected on the predetermined n second unit surfaces, the beams are integrated into a beam traveling in a direction parallel to the optical axis of the predetermined first unit surface.

Accordingly, the compact integrator having the beam integrating function is obtained.

An illuminating apparatus according to one embodiment of the invention includes n light sources; and the integrator according to one embodiment. In the illuminating apparatus, light beams emitted from n light sources are incident to the predetermined first unit surface at the predetermined angle as n beams traveling in different directions, and the light beams are integrated into a beam traveling in a direction parallel to the optical axis of the predetermined first unit surface by the integrator.

Accordingly, the compact illuminating apparatus having the illuminance uniformizing function and the beam integrating function is obtained.

In an illuminating apparatus according to another embodiment, the n light sources emit light beams having at least two wavelengths.

Accordingly, the compact illuminating apparatus having the illuminance uniformizing function and the function of switching or mixing light beams having at least two wavelengths is obtained.

In an integrator according to one embodiment, a size of a section of the predetermined first unit portion is n times a size of a section of each of the predetermined n second unit portions. The section of the predetermined first unit portion is perpendicular to the optical axis of the predetermined first unit portion, and the section of each of the predetermined n second unit portions is perpendicular to the optical axis of the predetermined first unit portion.

Accordingly, the size of the first member is conveniently equalized to the size of the second member.

In an integrator according to another embodiment, the predetermined first unit portions are disposed in the first member with no gap therebetween.

The integrator of the embodiment is efficient because of no loss of the light incident to the first member.

In an integrator according to another embodiment, the predetermined second unit portions are disposed in the second member with no gap therebetween.

The integrator of the embodiment is efficient because of no loss of the light incident to the second member.

In an integrator according to another embodiment, a section of the predetermined first unit portion and a section of each of the predetermined n second unit portions have square shapes. The section of the predetermined first unit portion is perpendicular to the optical axis of the predetermined first unit portion, and the section of each of the predetermined n second unit portions is perpendicular to the optical axis of the predetermined first unit portion.

Accordingly, the square illuminated region is conveniently irradiated.

In an integrator according to another embodiment, a section of the predetermined first unit portion and a section of each of the predetermined n second unit portions have rectangular shapes. The section of the predetermined first unit portion is perpendicular to the optical axis of the predetermined first unit portion, and the section of each of the predetermined n second unit portions is perpendicular to the optical axis of the predetermined first unit portion.

Accordingly, the rectangular illuminated region is conveniently irradiated. The rectangle is formed into a rectangle having an aspect ratio close to that of the image pickup device or image modulation element, which allows the illuminated region to be efficiently irradiated.

In an integrator according to another embodiment, a section of the predetermined first unit portion and a section of each of the predetermined n second unit portions have regular hexagonal shapes. The section of the predetermined first unit portion is perpendicular to the optical axis of the predetermined first unit portion, and the section of each of the predetermined n second unit portions is perpendicular to the optical axis of the predetermined first unit portion.

Accordingly, the circular illuminated region is conveniently irradiated. In the microscope and the like, the circular illuminated region can conveniently be irradiated.

In an integrator according to another embodiment, after light that is incident to a surface on an incident side in each of the predetermined n second unit portions and parallel to the optical axis of the predetermined first unit portion is collected on a surface on an output side in the predetermined first unit portion, the light is split into n beams traveling in different directions.

Accordingly, the compact integrator having the beam splitting function is obtained.

An illuminating apparatus according to one embodiment of the invention includes a light source; collimating means; and the integrator according to one embodiment. In the illuminating apparatus, after light emitted from the light source is formed into light parallel to the optical axis of the predetermined first unit portion by the collimating means, the light is incident to the predetermined n second unit portions, and the light is split into n beams traveling in different directions by the integrator.

Accordingly, the compact illuminating apparatus having the illuminance uniformizing function and the beam splitting function is obtained.

In an integrator according to another embodiment, after n beams that travel in different directions to be incident to a surface on an incident side in the predetermined first unit portion at a predetermined angle are collected in a surface on an output side in the predetermined n second unit portions, the beams are integrated into a beam traveling in a direction parallel to the optical axis of the predetermined first unit surface.

Accordingly, the compact integrator having the beam integrating function is obtained.

An illuminating apparatus according to one embodiment of the invention includes n light sources; and the integrator according to one embodiment. In the illuminating apparatus, light beams emitted from the n light sources are incident as n beams traveling in different directions to a surface on an incident side in the predetermined first unit portion at the predetermined angle, and the light beams are integrated into a beam traveling in a direction parallel to the optical axis of the predetermined first unit surface by the integrator.

Accordingly, the compact illuminating apparatus having the illuminance uniformizing function and the beam integrating function is obtained.

In an integrator according to one embodiment of the invention, a size of a section of each of the predetermined in first unit surfaces is n/m times a size of a section of each of the predetermined n second unit surfaces. The section of each of the predetermined m first unit surfaces is perpendicular to the optical axis of the first refractive surface, and the section of each of the predetermined n second unit surfaces is perpendicular to the optical axis of the second unit surface.

Accordingly, the size of the first surface is conveniently equalized to the size of the second surface.

In an integrator according to another embodiment, after n beams that travel in different directions to be incident to the predetermined m first unit surfaces at a predetermined angle are collected and integrated into the predetermined n second unit surfaces, the beams are split into m beams traveling in different directions.

Accordingly, the compact integrator having the beam splitting function is obtained.

An illuminating apparatus according to one embodiment of the invention includes n light sources; and the integrator according to one embodiment. In the illuminating apparatus, light beams emitted from the n light sources are incident as n beams traveling in different directions to the predetermined m first unit surfaces at the predetermined angle, and the light beams are split into m beams traveling in different directions by the integrator.

Accordingly, the compact illuminating apparatus having the illuminance uniformizing function and the beam splitting function is obtained.

In an integrator according to one embodiment, a size of a section of each of the predetermined m first unit portions is n/m times a size of a section of each of the predetermined n second unit portions. The section of each of the predetermined m first unit portions is perpendicular to the optical axis of the first member, and the section of each of the predetermined n second unit portions is perpendicular to the optical axis of the second member.

Accordingly, the size of the section perpendicular to the optical axis of the first member is conveniently equalized to the size of the section perpendicular to the optical axis of the second member.

In an integrator according to another embodiment, after n beams traveling in different directions that are incident to the predetermined m first unit portions at a predetermined angle are collected and integrated into the predetermined n second unit portions, the beams are split into m beams traveling in different directions.

Accordingly, the compact integrator having the beam splitting function is obtained.

An illuminating apparatus according to one embodiment of the invention includes n light sources; and the integrator according to one embodiment. In the illuminating apparatus, light beams emitted from the n light sources are incident as n beams traveling in different directions to the predetermined m first unit surfaces at the predetermined angle, and the light beams are split into m beams traveling in different directions by the integrator.

Accordingly, the compact illuminating apparatus having the illuminance uniformizing function and the beam splitting function is obtained.

The invention claimed is:

1. An integrator comprising first and second surfaces, wherein
the first surface includes a first unit surface that is of a positive refractive surface,
the second surface includes a second unit surface that is of a positive refractive surface,
predetermined n second unit surfaces correspond to a predetermined first unit surface,
light that is parallel to the optical axis of the predetermined first unit surface and incident to each of the predetermined n second unit surfaces is collected in a center of the predetermined first unit surface, and
the predetermined n second unit surfaces are disposed so as not to be adjacent to one another on a refractive surface having a refractive power substantially identical to that of the refractive surface of the predetermined first unit surface, where n and m represent positive integers.

2. The integrator according to claim 1, wherein a size of a section of the predetermined first unit surface is n times a size of a section of each of the predetermined n second unit surfaces, the section of the predetermined first unit surface being perpendicular to the optical axis of the predetermined first unit surface, the section of each of the predetermined n second unit surfaces being perpendicular to the optical axis of the predetermined first unit surface.

3. The integrator according to claim 1, wherein first unit surfaces each of which acts as the predetermined first unit surface are disposed in the first surface with no gap therebetween.

4. The integrator according to claim 1, wherein second unit surfaces each set of which acts as the predetermined n second unit surfaces are disposed in the second surface with no gap therebetween.

5. The integrator according to claim 1, comprising one optical element.

6. The integrator according to claim 1, comprising:
a first optical element including a surface in which the first unit surface is formed; and
a second optical element including a surface in which the second unit surface is formed.

7. The integrator as claim 1, wherein, after light that is parallel to the optical axis of the predetermined first unit surface and incident to each of the predetermined n second unit surfaces is collected on the predetermined first unit surface, the light is split into n beams traveling in different directions.

8. An illuminating apparatus comprising:
a light source;
collimating means; and
the integrator according to claim 7,
wherein, after light emitted from the light source is formed into light parallel to the optical axis of the predetermined first unit surface by the collimating means, the light is incident to the predetermined n second unit surfaces, and the light is split into n beams traveling in different directions by the integrator.

9. The integrator according to claim 1, wherein, after n beams that travel in different directions to be incident to the predetermined first unit surface at a predetermined angle are collected on the predetermined n second unit surfaces, the beams are integrated into a beam traveling in a direction parallel to the optical axis of the predetermined first unit surface.

10. An illuminating apparatus comprising:
n light sources; and
the integrator according to claim 9,
wherein light beams emitted from the n light sources are incident as n beams traveling in different directions to the predetermined first unit surface at the predetermined angle, and the light beams are integrated into a beam traveling in a direction parallel to the optical axis of the predetermined first unit surface by the integrator.

11. An integrator comprising first and second members, wherein
the first member includes a first unit portion having a positive refractive power,
the second member includes a second unit portion having a positive refractive power,
predetermined n second unit portions correspond to a predetermined first unit portion,
light that is parallel to the optical axis of the predetermined first unit portion and incident to a surface on an incident side in each of the predetermined n second unit portions is collected in a center of a surface on an output side in the predetermined first unit portion, and
the predetermined n second unit portions are disposed so as not to be adjacent to one another on a member having a refractive power substantially identical to the refractive power of the predetermined first unit portion, where n and m represent positive integers.

12. The integrator according to claim 11, wherein a size of a section of the predetermined first unit portion is n times a size of a section of each of the predetermined n second unit portions, the section of the predetermined first unit portion being perpendicular to the optical axis of the predetermined first unit portion, the section of each of the predetermined n second unit portions being perpendicular to the optical axis of the predetermined first unit portion.

13. The integrator according to claim 11, wherein first unit portions each of which acts as the predetermined first unit portion are disposed in the first member with no gap therebetween.

14. The integrator according to claim 11, wherein the predetermined second unit portions are disposed in the second member with no gap therebetween.

15. The integrator according to claim 11, comprising one optical element.

16. The integrator according to 11, wherein, after light that is parallel to the optical axis of the predetermined first unit portion and incident to a surface on an incident side in each of the predetermined n second unit portions is collected on a surface on an output side in the predetermined first unit portion, the light is split into n beams traveling in different directions.

17. An illuminating apparatus comprising:
a light source;
collimating means; and
the integrator according to claim 16,
wherein, after light emitted from the light source is formed into light parallel to the optical axis of the predetermined first unit portion by the collimating means, the light is incident to the predetermined n second unit portions, and the light is split into n beams traveling in different directions by the integrator.

18. The integrator according to claim 11, wherein, after n beams that travel in different directions to be incident to a surface on an incident side in the predetermined first unit portion at a predetermined angle are collected in a surface on an output side in the predetermined n second unit portions, the beams are integrated into a beam traveling in a direction parallel to the optical axis of the predetermined first unit portion.

19. An illuminating apparatus comprising:
n light sources; and
the integrator according to claim 18,
wherein light beams emitted from the n light sources are incident as n beams traveling in different directions to a surface on an incident side in the predetermined first unit portion at the predetermined angle, and the light beams are integrated into a beam traveling in a direction parallel to the optical axis of the predetermined first unit portion by the integrator.

20. An integrator comprising first and second surfaces, wherein
the first surface includes a first unit surface that is of a positive refractive surface,
the second surface includes a second unit surface that is of a positive refractive surface,
predetermined m first unit surfaces correspond to predetermined n second unit surfaces,
the predetermined m first unit surfaces are disposed on a first refractive surface so as not to be adjacent to one another,
the predetermined n second unit surfaces are disposed on a second refractive surface so as not to be adjacent to one another, and
the first refractive surface and the second refractive surface have a substantially identical refractive power and each of the first refractive surface and the second refractive surface is disposed near the focal point on the optical axe of the other, where n and m represent positive integers.

21. The integrator according to claim 20, wherein a size of a section of each of the predetermined m first unit surfaces is n/m times a size of a section of each of the predetermined n second unit surfaces, the section of each of the predetermined m first unit surfaces being perpendicular to the optical axis of the first refractive surface, the section of each of the predetermined n second unit surfaces being perpendicular to the optical axis of the second unit surface.

22. The integrator according to claim 20, wherein first unit surfaces each set of which acts as the predetermined m first unit surfaces are disposed in the first surface with no gap therebetween.

23. The integrator according to claim 20, wherein second unit surfaces each set of which acts as the predetermined n second unit surfaces are disposed in the second surface with no gap therebetween.

24. The integrator according to claim 20, comprising one optical element.

25. The integrator according to claim 20, comprising:
a first optical element including a surface in which the first unit surface is formed; and
a second optical element including a surface in which the second unit surface is formed.

26. The integrator according to claim 20, wherein, after n beams that travel in different directions and are incident to the predetermined m first unit surfaces at a predetermined angle are collected and integrated on the predetermined n second unit surfaces, the beams are split into m beams traveling in different directions.

27. An illuminating apparatus comprising:
n light sources; and
the integrator according to claim 26,
wherein light beams emitted from the n light sources are incident as n beams traveling in different directions to the predetermined m first unit surfaces at the predetermined angle, and the light beams are split into m beams traveling in different directions by the integrator.

28. An integrator comprising first and second members, wherein
the first member includes a first unit portion having a positive refractive surface,
the second member includes a second unit portion having a positive refractive surface,
predetermined m first unit portions correspond to predetermined n second unit portions,
the predetermined m first unit portions are disposed on the first member so as not to be adjacent to one another,
the predetermined n second unit portions are disposed on the second member so as not to be adjacent to one another,
refractive surfaces of the predetermined m first unit portions are parts of a first refractive surface,
refractive surfaces of the predetermined n second unit portions are parts of a second refractive surface, and
the first refractive surface and the second refractive surface have a substantially identical refractive power and each of the first refractive surface and the second refractive surface is disposed near the focal point on the optical axe of the other, where n and m represent positive integers.

29. The integrator according to claim 28, wherein a size of a section of each of the predetermined m first unit portions is n/m times a size of a section of each of the predetermined n second unit portions, the section of each of the predetermined m first unit portions being perpendicular to the optical axis of the first member, the section of each of the predetermined n second unit portions being perpendicular to the optical axis of the second member.

30. The integrator according to claim 28, wherein first unit portions each set of which acts as the predetermined m first unit portions are disposed in the first member with no gap therebetween.

31. The integrator as claim 28, wherein second unit portions each set of which acts as the predetermined n second unit portions are disposed in the second member with no gap therebetween.

32. The integrator according to claim 28, comprising one optical element.

33. The integrator according to claim 28, wherein, after n beams traveling in different directions that are incident to the predetermined m first unit portions at a predetermined angle are collected and integrated in the predetermined n second unit portions, the beams are split into m beams traveling in different directions.

34. An illuminating apparatus comprising:
n light sources; and
the integrator according to claim 33,
wherein light beams emitted from the n light sources are incident as n beams traveling in different directions to the predetermined m first unit surfaces at the predetermined angle, and the light beams are split into m beams traveling in different directions by the integrator.

35. The illuminating apparatus according to claim 27, wherein the n light sources emit light beams having at least two wavelengths.
